(19) United States
(12) Patent Application Publication
(10) Pub. No.: US 2011/0010624 A1
(43) Pub. Date: Jan. 13, 2011

(54) SYNCHRONIZING AUDIO-VISUAL DATA WITH EVENT DATA

(76) Inventors: Paul J. Vanslette, Upton, MA (US); Alpin C. Chisholm, North Attleboro, MA (US)

Correspondence Address: FISH & RICHARDSON P.C. (BO), P.O. BOX 1022, MINNEAPOLIS, MN, 55440-1022, US

(21) Appl. No.: 12/826,468

(22) Filed: Jun. 29, 2010

Related U.S. Application Data
(63) Continuation-in-part of application No. 12/500,927, filed on Jul. 10, 2009.
(60) Provisional application No. 61/314,059, filed on Mar. 15, 2010.

(51) Int. Cl. G06F 3/048; G06F 17/30

(52) U.S. Cl. 715/704; 715/764; 715/716

(57) ABSTRACT

Among other things, a user of a factory automation application that is presenting a graphical user interface at a user console, can select at least one of (a) a factory automation event or (b) a past time segment in the factory automation, and in response to the user selection. Then both (a) stored audio-video factory automation content, and (b) stored audio-video console content, for the selected event or time segment are presented.

This application is a continuation in part of U.S. patent application Ser. No. 12/500,927, filed Jul. 10, 2009, and also claims the benefit of the filing date of U.S. provisional patent application Ser. 61/314,059, filed Mar. 15, 2010, both of which are incorporated herein by reference in their entirety.

### BACKGROUND

This description relates to synchronizing audio-visual data with event data.

In environments such as factories, sensor data is often stored in a data archive that records the history of the sensor states. Video clips of equipment on the factory floor may also be archived. A user can link the playback of video data and sensor data by storing the actual video, or a reference to the video file, and the start and stop points of the video of interest, as an object within an application.

### SUMMARY

In general, in an aspect, a user of a factory automation application that is presenting a graphical user interface at a user console, can select at least one of (a) a factory automation event or (b) a past time segment in the factory automation, and in response to the user selection. Then both (a) stored audio-video factory automation content, and (b) stored audio-video console content, for the selected event or time segment are presented.

Implementations may include one or more of the following features. The presentations of the stored factory automation content and the stored console content are coordinated in time. The user can select the factory automation event from a list of events. The user can select the past time on a graphically presented time scale. The audio-video factory automation content comprises a video capture of a factory automation step. The console content comprises a video capture of the console screen. The stored factory automation content and the stored audio-video console content are presented simultaneously.

In general, in an aspect, a user of a graphical user interface of an audio-video presentation application, can select a combination of (a) an item of stored audio-video console content associated with an event or time segment of factory automation, and (a) one or more items of stored audio-video factory automation content also associated with the event or time segment. Then the combination of content items is displayed simultaneously to the user, the presentation of the content items being coordinated in time.

Implementations may include one or more of the following features. The audio-video presentation application is used by a different person than the person who used a factory automation application that was the subject of the stored audio-video console content.

In general, in an aspect, a message is located that was stored in a database of a factory automation system based on a string of characters that were pre-specified by a user of the system as being associated with an identified audio-video source of the factory automation system. In connection with a user selecting the message in a user interface, previously stored audio-video content associated with the identified audio-video source is automatically presented.

Implementations may include one or more of the following features. The database comprises an SQL database. An icon is displayed with the message in the user interface, and the user can invoke the icon to cause the previously stored audio-video content to be presented. The audio-video source comprises a video camera or a video capture application.

These and other features and aspects, and combinations of them, may be expressed as methods, apparatus, systems, components, methods of doing business, means or steps for performing functions, and in other ways.

Other advantages and features will become apparent from the following description and from the claims.

### DESCRIPTION

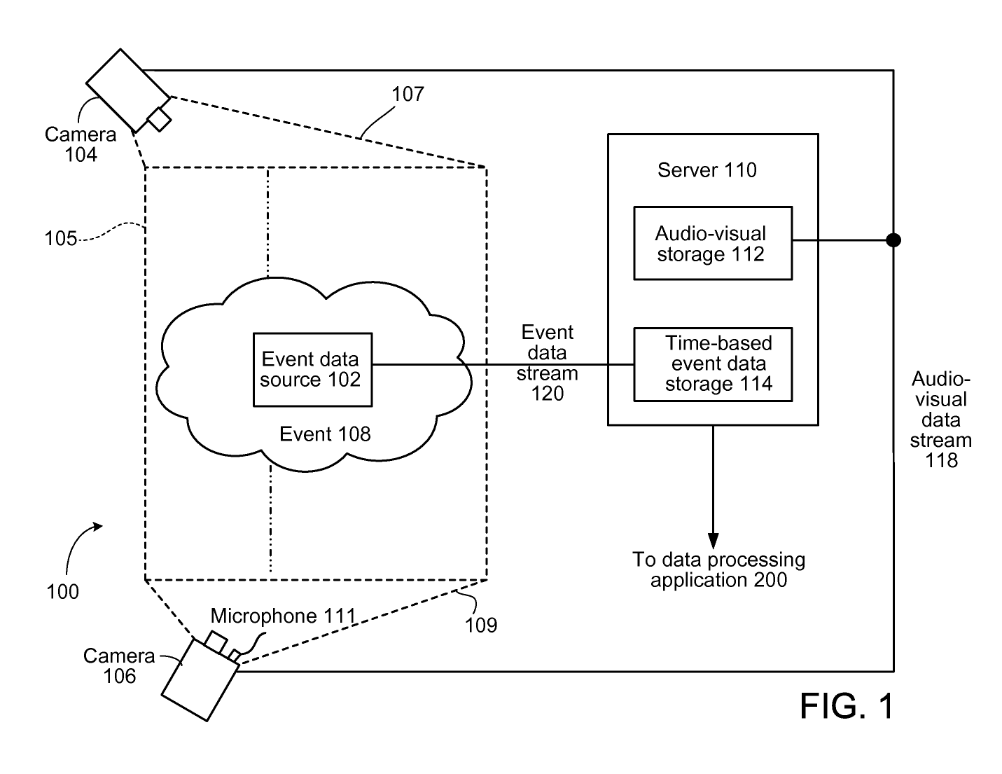

FIGS. 1 through 5 are block diagrams.

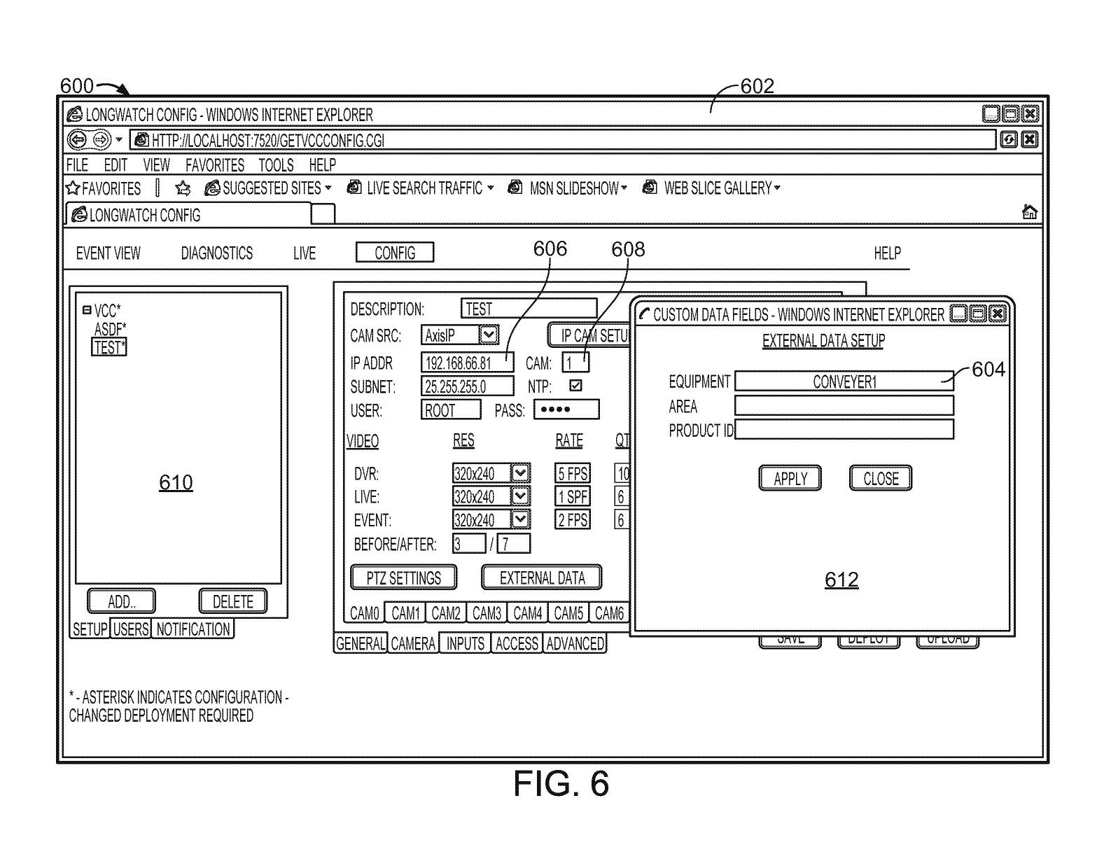

FIGS. 6 through 8 are screenshots of a user interface.

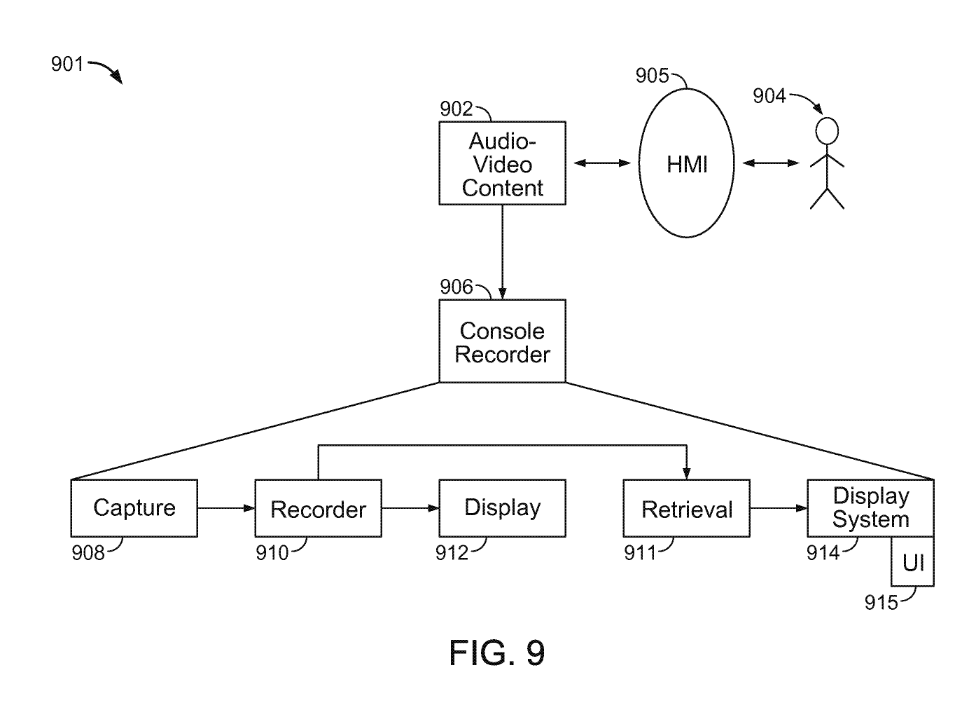

FIGS. 9 through 12, 19, and 21 are block diagrams.

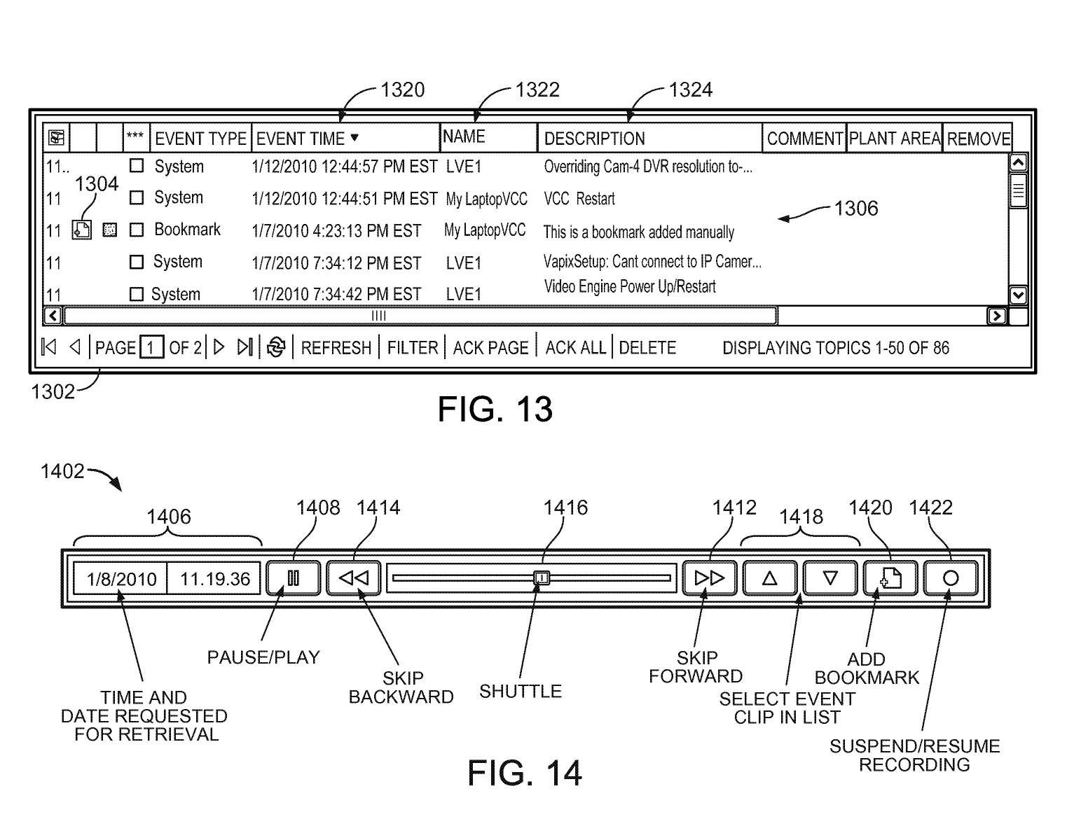

FIGS. 13 through 18, 20, and 22 through 25 are screenshots.

As shown in FIG. 1, a system 100 monitors events such as adding hopsto a wort tank at a brewery. In the example of FIG. 1, the system includes video cameras 104 and 106 (which are examples of audio-video capture devices), however, the system is scalable and can support any number of cameras, from one to many. The cameras can be positioned to record an environment 105 that is within the field of view 107 of camera 104 and within the field of view 109 of camera 106. An exemplary environment could be an area of a factory showing the brewhouse floor described above, containing a number of vessels. One camera might have a field of view for all vessels within the brewhouse, while other cameras might have their fields of view limited to one or two vessels. In some examples, each camera may pan, tilt and zoom to change the field of view. Each camera may also include a microphone 111 to acquire audio data or to trigger an event of interest.

The system 100 also includes an event data source 102, which may include one or more sensors, alarms, or other devices that detect the occurrence of events 108. Each event data source 102 can also associate each event 108 with a time period of occurrence during which an event occurs. For example, the event data source 102 can detect if a hatch is opened on a wort kettle and can associate a time period of occurrence with that event, in other words the period during which the hatch remains open. Event data collected by the event data source can be sensor data collected automatically and at specific time periods (e.g. once a second), or can be data associated with text alarm messages, or in other ways. In some examples, when the event data is an alarm message, the time of the event is included within the text string of the message. In some cases, the occurrence of the event may have been indicated by a user entering data or otherwise identifying the event through a user interface.

In FIG. 1, the cameras 104 and 106 and the event data source 102 are positioned and configured to record events 108 that are associated with the field of view of both cameras, and within the range of the event data source. The cameras record audio-visual (we sometimes use a similar phrase, audio-video) data and transmit audio-visual data streams 118 (in this case two streams) to an audio-visual storage element 112 within a server 110 (e.g., a hard drive). The server 110 is shown as a single machine in the example of FIG. 1; however, the functions of the server 110 could be performed in a distributed manner by any number of machines and components connected on a network.

Similarly, the event data source 102 gathers data related to the occurrence (or non-occurrence) of the event 108. Each event data source 102 transmits an event data stream 120 to an event data storage element 114 within the server 110. Each data stream (e.g., a stream of measurements and status of a sensor) may or may not have an associated time stamp for each event in the stream. In some examples, the status of the event data source may cause a different system component to apply a time stamp to data within the data stream. For example, each of the audio-visual data streams 118 and each of the event data streams 120 can include data recorded by the cameras 104 and 106 and the event data source 102, respectively. Both the audio-visual data streams 118 and the event data stream 120 can be transmitted over a wireless network, a wired network, or a network that includes both wireless and wired connections. An example of a low bandwidth network that may be suitable for the communications described above is described in U.S. application Ser. No. 11/052,393, which is incorporated here by reference.

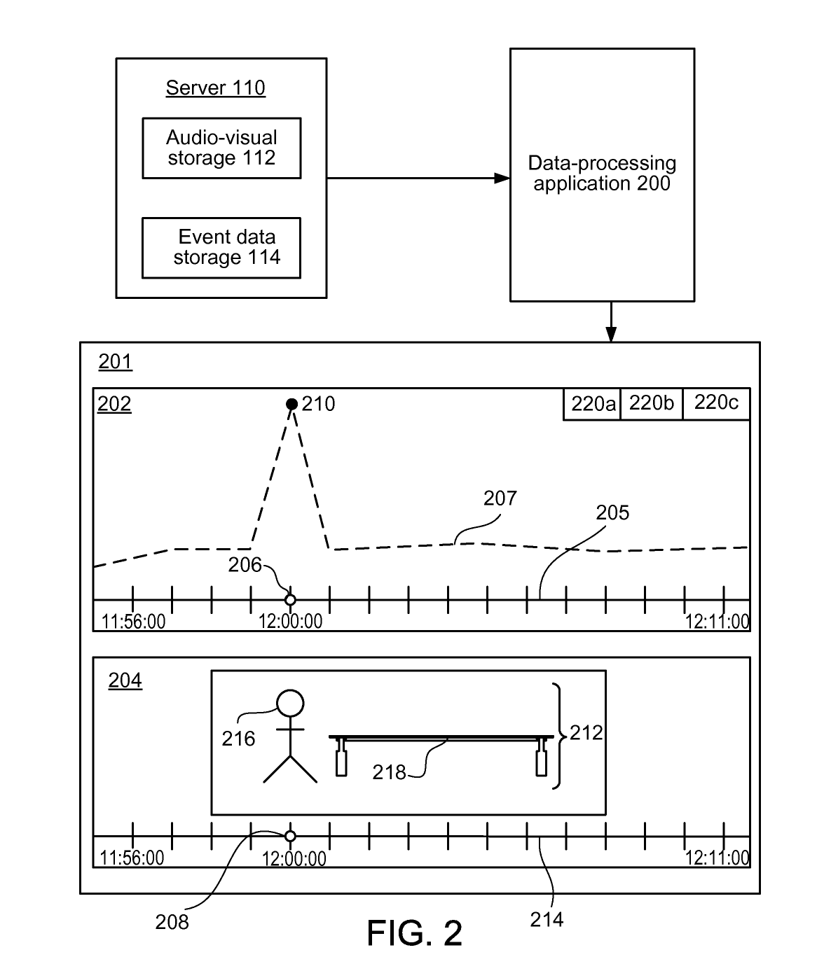

As shown in FIG. 2, the server 110 communicates with a data processing application 200. The data processing application receives data from the server 110 (from both audio-visual storage element 112 and event data storage element 114), processes the data, and generates an output that can be used to drive an interface 201. The interface 201 can be displayed on an electronic display and can be launched using an Internet browsing application. In some examples, the interface can run on specially designed software (for example, when controls, such as ActiveX controls, are added to a user's Human Machine Interface-HMI-software display). The electronic display could be a dedicated terminal or any number of personal computers with access to the audio-visual data stream 118 and the event data stream 120 (FIG. 1).

Interface 201 includes an event grid 202 and a video window 204. The Event grid 202 can be displayed in a variety of formats such as graphical or textual format. A control, such as an ActiveX control, within the interface can connect to the server in order to retrieve the video data and display a video within the interface. The event grid 202 and the video window 204 can have a number of shapes, sizes, aspect ratios, and settings. The video window 204 can also display more than one video clip. For example, the video window 204 can display three video clips that are associated with three different sources of audio-visual data. The interface can be a user interface that is displayed on an electronic display. In some examples, the event grid 202 displays information related to an event 108 (FIG. 1) that was collected by the event data source 102 (FIG. 1) and that was stored in the event data storage element 114.

The event grid includes a timeline 205 and a time cursor 206. The time cursor indicates a current time of interest, for example, time 12:00:00. In the illustrated example, the timeline 205 spans a range of time that begins at 11:56:00 and ends at 12:11:00. A user (or some other process) can change the position of the time cursor 206 (to the left or to the right) on the timeline 205 in order to indicate a new time of interest. Changing the position of the time cursor can also shift the range of time displayed by the event grid. For example, moving the time cursor 206 toward the right end of timeline 205 (e.g., by clicking the time cursor with a mouse and dragging the time cursor across the electronic display) would advance the current time of interest and would shift the range of displayed time to include a different range of times. In some implementations, the time of interest and the displayed range of time could be adjusted separately. Additionally, the scale of the event grid could also be adjusted (e.g., the time period could be adjusted to display event data over a period of hours instead of minutes and seconds).

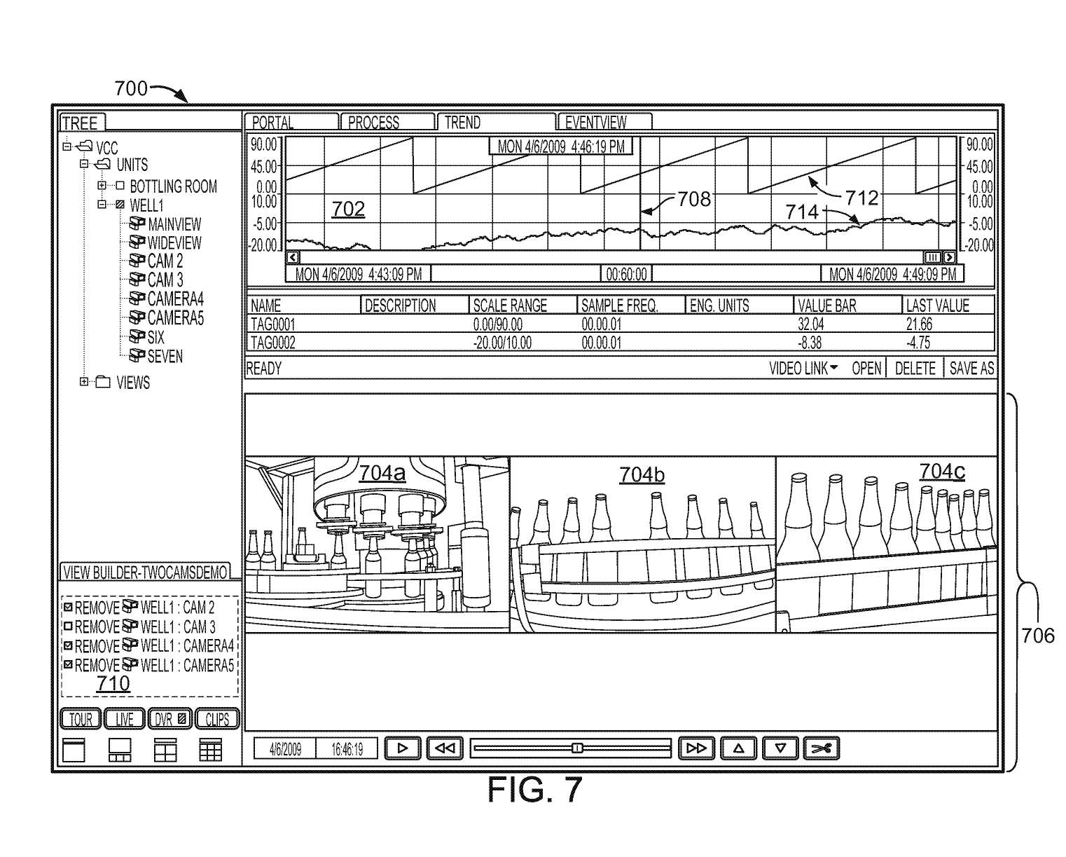

The event grid 202 can display, for example, a trend chart 207 (see also the example of FIG. 7). The trend chart provides a visual representation of the data generated by an event data source 102 (FIG. 1). In this example, the trend chart shows that an event 210 has occurred at 12:00:00. Because the time cursor 206 is positioned at 12:00:00, the video window 204 will display audio-visual information 212 (such as a video clip) that shows what is happening over a period of time that includes the time 12:00:00. As a result, in this particular example, the video window will display audio-visual frames associated with the occurrence of the event 210. For example, playing back audio-visual frames associated with an event that has occurred at 12:00:00 can cause the video window to display a video that begins at 12:00:00 or at an earlier time.

For instance, at time 12:00:00, the trend chart 207 within event grid 202 shows the occurrence of the event 210. At the same time, the video window 204 displays audio-visual information 212 (e.g., a person 216 standing next to a table 218) at 12:00:00. That is, at time 12:00:00, the audio-visual information would be a single frame that was captured at time 12:00:00. The single frame shown at time 12:00:00 could be the first frame of a video played back from that point in time (e.g., the first frame in a sequence of frames that make up a video segment). A second time cursor 208 is positioned at 12:00:00 on a second timeline 214 indicating that the audio-visual data being displayed in video window 204 coincides with the time selected in the event grid 202. In this way, the event data and the audio-visual data are synchronized. A user can select a point (e.g., an event 210) on the trend chart 207 to obtain further information about the selected point. Further information related to the selected point can be displayed as numerical information when a user “hovers” a mouse cursor over a point on the trend chart, or when the user selects a point on either the trend chart 207 or the timeline 205.

A user can use traditional tools (such as timelines 205, 214, and time cursors 206, 208) to navigate to different times on either the event grid 202 or the video window 204. In addition to the timelines and time cursors, the interface 201 can also include navigation and display format controls for user convenience.

The event grid can also contain tabs 220a, 220b, and 220c that are selectable by a user (e.g., by clicking a tab with a pointer using a mouse). Each tab can cause the event grid to display different types of information and behavior. For example, an “Event” tab displays information in a tabular grid format rather than in a graphical format. Each line in such a grid may represent an occurrence of an event. The data associated with the event can be organized in columns. For example, one column can represent the time of the event, and another column can represent the name of the event data source that detected or triggered the event. Another column can represent the type of message (event messages may be alarms requiring action by the user, or status messages simply informing the user). If a video clip is associated with the event, then the software prefixes the message line with a graphic icon indicating to the user that video is attached. Clicking on the icon causes the video to appear and play automatically. A camera database may include user-definable attributes (e.g., labels). Upon the detection of an event, an associated event message will be constructed with the contents of these attributes. The message is placed in the database that represents the Event tab (e.g., a relational database). The interface enables messages to be filtered and sorted using this information.

In some examples, the presentation of a “Process” tab is similar to the presentation of the Event tab. In the Process tab, the grid is populated by extracting alarm message data from a separate data collection/alarm management system using Structured Query Language (SQL). Once that data has been collected, the software determines whether there are any strings within the alarm message that match the tracking strings in the camera configuration data. If there are strings within the alarm message that match, the software prefixes the message line with a graphic icon indicating that video is associated. When the user clicks on the icon, the video is displayed. (The mechanism for retrieving the video in this instance is different than the mechanism used for the “Event” tab).

A “portal” tab can display a URL address or HTML file that the user has pre-configured. The behavior and display characteristics of this tab are dependent on the URL/HTML that the user has specified.

In some examples, if the event grid is linked to the video playback system, the video will move forward or backward in time as the user shifts the time cursor 206 along the timeline 205. If the data is being presented as a grid, when the user clicks on an event, the corresponding video clip is presented. Similarly, audio-visual data can be linked to event data. For example, when a desired segment of video is found, the system can automatically shift the time of the trend chart to the point in time corresponding with the point in time of the audio-visual data being played. The “linked” or “synchronized” playback of the audio-visual data and the event data allows a user to obtain further information about a time of interest. Furthermore, if a user is viewing video playback in the video window, the user can stop playback of the video at a desired point, and then activate a “link” button (not shown) to automatically display event data corresponding to the point in time selected in the video window.

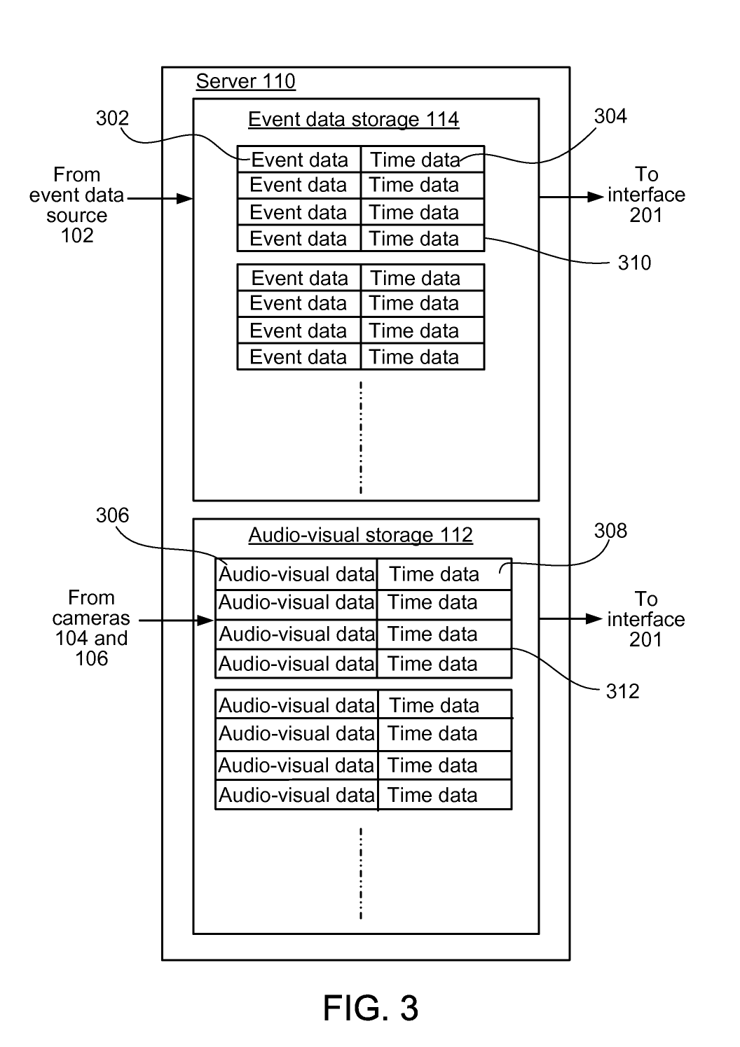

FIG. 3 is a simplified example that shows how the server 110 could store data. The server includes the previously described event data storage 114. The event data storage 114 stores one or more files 310. The file 310 includes both event data 302 and time data 304. The event data 302 indicates the occurrence (or non-occurrence) of an event. Using the previous example, if a worker within the beverage plant opens a hatch to add syrup to a tank, the event data 302 could indicate that a hatch had been opened on the tank. The time data 304 could indicate the relevant time period associated with the corresponding event data (e.g., the time at which the hatch was opened). In some examples, each unit of event data 302 is associated with a corresponding unit of time data 304. The file 310 can hold any amount of event data 302 and time data 304.

The server 110 also includes an audio-visual storage 112. The audio-visual storage 112 receives the audio-visual data stream 118 (FIG. 1) from cameras 104 and 106, and stores audio-visual data 306 in a file 312. The audio-visual data 306 can include either or both audio and video data or images or any other kind of audible or visible material. In some examples, video data describes a moving succession of frames with or without audio while audio data describes data representative of captured sound (e.g., sound captured by microphone 113 in FIG. 1). An example of the audio-visual data that could be stored in file 312 is a video clip that shows the bottle falling off of the conveyor belt. The time data 308 can indicate the relevant time period associated with the corresponding audio-visual data (e.g., the period of time spanned by the video clip). The file 312 can hold any amount of audio-visual data 306 and time data 308.

Both the event data storage 114 and the audio-visual data storage 112 provide an output that eventually reaches the interface 201. Additional data storage elements and data processing elements can be located between the data sources (e.g., cameras 104 and 106 and event data source 102) and the interface 201. In some examples, if a user navigates to a point in time within the event grid 202, the interface 201 will use a timestamp representing that point in time to locate audio-visual data with a timestamp from the same point in time. That is, the interface can use a timestamp from either the event data or the audio-visual data to navigate to the relevant portion of the other of the event data or the audio-visual data of point in time. For example, a user may wish to view, in the event grid, an event representing that a hatch has been opened on a tank (e.g., at a time 12:00:00 AM). Using a timestamp (e.g., time data 304), the interface can locate audio-visual data that has a timestamp (e.g., time data 306) from the same point in time. The timestamp might not be the only criterion for locating audio-visual data. For example, audio-visual data can also be located based on the camera that recorded the audio-visual data.

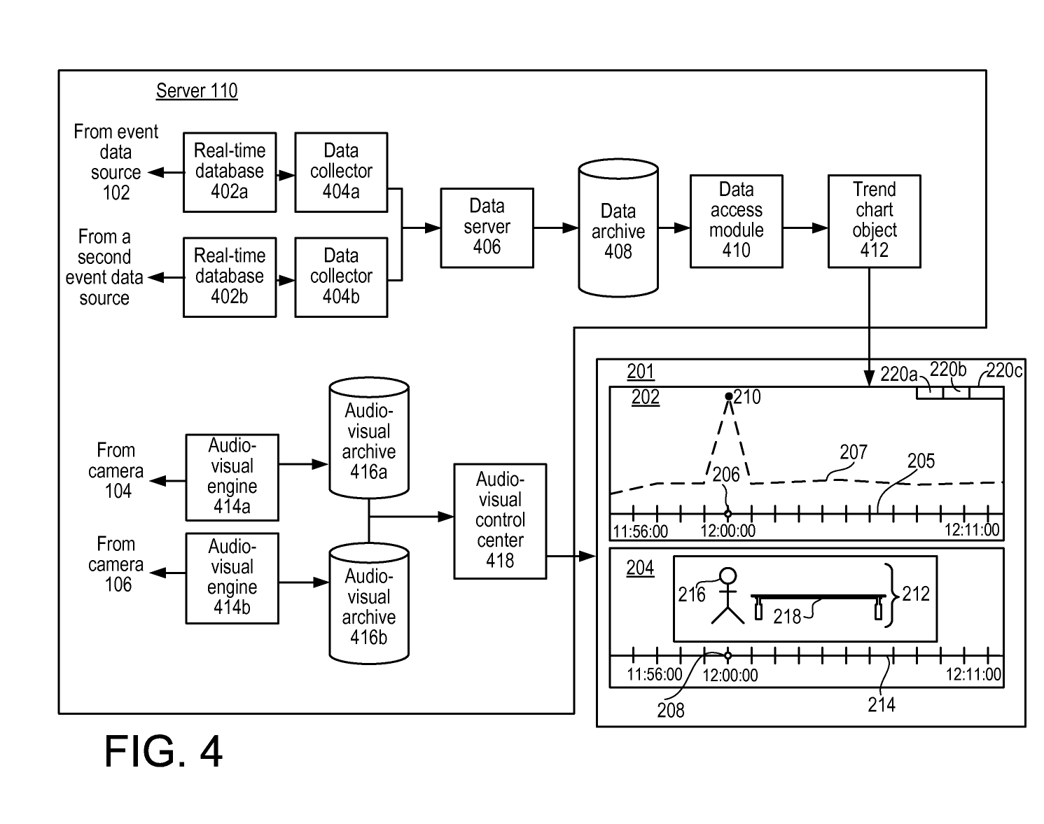

FIG. 4 is a more detailed exampled that shows how data is gathered from the data sources (e.g., cameras 104 and 106 and event data source 102) and processed to user interface 201. The server 110 may have one or more networked “real time databases” 402a and 402b. The real time databases contain event data and time data of event data sources. The information stored within the real time databases can change over time based on the conditions being monitored by event data sources. Each real time database 402a and 402b may have one or more data collectors 404a and 404b that takes samples of pre-selected data stored in the real-time databases (e.g., event data and time data). The data server 406 can be a program that collects the data from the event data sources, organizes the data into files (e.g., in formatted tables), and stores them in a data archive 408 as one or more files (FIG. 3).

The data access module 410 retrieves information from the data archive 408 (generally addressed by tag name and span of time desired), expands it (if necessary) and delivers the information to the requesting program (e.g., interface 201). Some data is saved in a compressed mode in order to save disk space. If a value remains substantially constant (e.g., within a selectable band where no change occurs) over time, then the initial value is written and a subsequent value is written when the value changes substantially. When the data files are retrieved, the software “expands” the two entries so that it looks to the receiving application like a multitude of samples were taken and stored.

Trend chart object 412 is an object (e.g., an ActiveX control) that can be placed into display software (e.g., interface 201). In some examples, the trend chart object 412 displays the event data retrieved from the data archive 408 as a set of one or more colored lines in a time-versus-value chart such as the trend chart 207 within the event grid 202.

Audio-visual engines 414a and 414b collect audio-visual data from cameras 104 and 106. The collected audio-visual data is stored in one or more files within one or more audio-visual archives 416a and 416b. As shown in FIG. 3, the stored files can contain both audio-visual data and time data. The audio-visual control center 418 controls playback of the audio-visual data (e.g., play, pause, rewind, forward) based on commands received from the user interface. The audio-visual control center 418 may act as the “central server” for the playback system. The audio-visual control center may be the central point of configuration, and may contain the software that drives the controls (e.g., ActiveX controls), the interface displayed in the browser, and other applications.

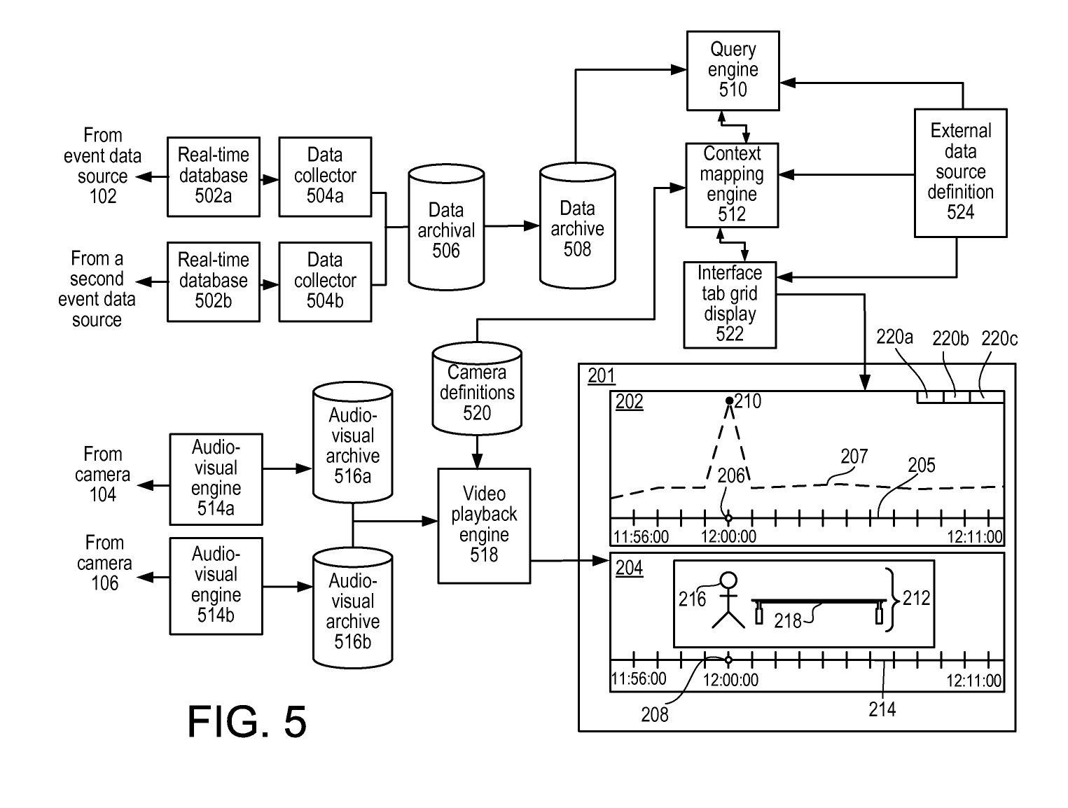

In the example of FIG. 5, one or more networked “real time databases” 502a and 502b may contain event data and time data received from the event data sources. The information stored within the real time databases can change over time based on the conditions being monitored by the event data sources. Each real time database 502a and 502b may have one or more data collectors 504a and 504b that takes samples of pre-selected data stored in the real-time databases (e.g., event data and time data). Audio-visual data is continuously collected by audio-visual engines 514a and 514b and stored into one or more files within one or more audio-visual archives 516a and 516b. Data archival element 506 can be a standard SQL database that can contain events, alarms, production values, quantities, statuses, batch records, manual actions identified by employee ID, or other data. The data within data archival element 506 may have a time stamp associated with the data. Data archive 508 is a centralized collection of multiple instances of 506 (e.g., a conglomeration of databases from a distributed system architecture). Query engine 510 is part of a video historian which accesses and queries the data archive 508 as requested/needed based on information provided from external data source definition 524. The external data source definition 524 provides describes which external tables to access, how to access them, and other functions.

In some examples, context mapping engine 512 takes the results of the query in 510, associates the information between the camera definitions in 520 and the external data source definitions in 524 and adds camera/navigation context for that event record (e.g., it creates the record marking that causes interface tab grid display 522 to display a camera icon in the appropriate display record). Interface tab grid display 522 generates a user interface for the data based on column definitions and user preferences provided in external data sources definitions 524. The interface tab grid display 522 may also modify or extend the time stamp from the data archive 508 so that the video playback engine 518 will retrieve the correct stored video according to its timestamp.

A video playback engine 518 provides a means to control playback of the audio-visual data (e.g., play, pause, rewind, forward) based on parameters received from the interface 201. Exemplary parameters received from the interface that can be used to control playback of the audio-visual data include the selection of a specific camera and/or a time period. For example, a user may choose to view audio-visual data collected by camera 104 or camera 106 (or both) in the video window 204. A user may provide these parameters by selecting automatically generated clickable icons (not shown) that cause a change in playback when activated with a mouse cursor. The icons can appear within the interface as icons, radio buttons, or any other graphical representation that can be activated by user input.

In some examples, the clickable icons represent a list of cameras associated with a particular event record. For example, if the event of interest is a hatch being opened on a particular tank, a user may be able to select between a number of different cameras which may have recorded this event from different angles, distances, or resolutions.

A camera that records an event is referred to as being “mapped” to the event data that corresponds to that event. One way of mapping event data to a camera is to assign an event data source to one or more cameras. When the event data source provides an indication of an occurrence of an event, software “captures” the video clip from the associated camera or cameras. In some examples, one or more cameras can be mapped from text strings extracted from a database 508 and processed in 512 (e.g., the Process tab). For example, camera definitions 520 data can store attributes that are modifiable by a user (sometimes referred to as “extended data attributes”). These extended data attributes can be named by the user to associate a camera with a number of sources of event data (see FIG. 6, described below).

For example, a factory may contain a first conveyor belt (“CONVEYOR1”) for transporting bottles. A user may modify the extended data attributes associated with a camera (e.g., camera 104 in FIG. 1) so that a camera is associated with CONVEYOR1 (that is, audio-visual data generated by a camera will be associated with the data source CONVEYOR1). This association is stored in camera definitions 520. If the first conveyor belt stops, a sensor can generate event data in a format such as “CONVEYOR1_STOP” which is then passed by a query engine 510 to a context mapping engine 512 to determine whether any cameras are associated with the event data. Because the event data contains information that identifies the source of the event (CONVEYOR1), when the context mapping engine accesses the camera definitions 520 to determine whether any cameras are associated with CONVEYOR1, it will identify the camera that is mapped to the event data. A camera can be associated with more than one event data source, such as CONVEYOR1 and CONVEYOR2 and an event source can be mapped to multiple cameras, and vice-versa.

In some examples, the context mapping engine processes event data to determine which (if any) cameras are associated with the event data. If one or more cameras are associated with the event data, the interface 201 displays a list of camera identifiers as a clickable icon (not shown). As a result, a user can activate the icon (e.g., by clicking on the icon with a mouse cursor) to view audio-visual data collected from different cameras that are associated with the event data.

The context mapping engine performs the camera association by matching the list of extended data attributes (CONVEYOR1) against the appropriate column of data in the raw data set (for example, CONVEYOR1_STOP). The system does a partial string match from CONVEYOR1 to the Tagname (for example, CONVEYOR1_STOP would create a match with CONVEYOR1). If CONVEYOR1 is present in the raw data column, that camera is deemed to be associated with that event data. As a result, a new column is generated in the file (which may be called “camList”) that can identify one or more cameras that are associated with this the event data. For example, the camList column could be added as a third column to file 310 (FIG. 3).

FIG. 6 shows an exemplary interface 600 for modifying extended data attributes. The interface contains a list 610 of camera groups that include “Brew House” and “Packaging,” with camera Test being selected. In this example, the interface 600 runs in a browser 602 and contains a dialogue box 612. The dialogue box includes a field 604 in which a user can modify an extended data attribute for camera 1 (in this example, camera 1 is shown in a field 608, and has an IP address of 192.168.66.81 as shown in field 606). In this example, a user has entered CONVEYOR1 into the field 604 to associate the event data source CONVEYOR1 with camera 1. This yields a video batch tracking system that collects and associates video for batch processing, even when the equipment used by that batch processing is allocated at run-time.

In some examples, a user can create a new “tab” in the interface 201. A tab provides a way to bring in external data for correlation with the audio-visual data. The tabs allow a list of tabs to be extended, and provide a connection to an existing source of process data. The source of data is represented in the tabs (chart, grid, web page, etc). The SDK tab allows a way to add new tabs AND to allow objects in those tabs to control the video window streaming. We implemented tabs that map data to video mapping for two types of data. Historical Trending Pen Charting and relational data tabular data but the system can be applied to any data source. For Pen Chart we allow the user to synchronize on time between data and video, we allow groups of cameras to be associated with groups of collected data tags to provide easier association. For SQL data we provide a means to associate one or more cameras to a row of user data. Typically, each row is an event or alarm that has a time embedded within the row. A “smart video tag” icon is displayed for the user to click as another column to navigate to the right camera and time frame.

The following is a list of exemplary tabs: HTML page, Trend Chart, Process Tab, Event List, and Production Report. In some examples, the HTML page displays information that is supplied via a user-specified HTML file or URL. The Trend Chart displays information relating to event data. The Process Tab displays the alarm (or other application) messages taken from a third-party system (such as a human-machine-interface or batch management system) that is mapped to one or more cameras. The Event List which is a list of detected and managed events, along with any associated video clips. The Production Report tab can have a report generator that contains user-defined and user-formatted information (e.g., in a form similar to a spreadsheet) as well as one or more video panels contained within the report that can be clicked and thus show the selected video at selected points in time.

In some examples, a tab can consist of a name and a javascript object to facilitate the display of data and calls into the video to synchronize the video with the data set being presented. For a tab that will access a foreign data set (SQL table or View, for example), a query service definition file is defined (e.g., an .INI file). The query service definition file may contain some or all of the following information: SQL Connection string, name of table or view to access, list of columns to use, alias names, and default order, column name of time stamp mapping, column name for camera association lookup, and name of camera extended field (in camera definitions 520) used for association matching.

In the diagram, the SQL connection string and query parameters are used to access the raw data set that exists in an external data source definition 524. The list of columns and aliases are provided to the interface for the grid display. The mapping fields are passed to the mapping engine to provide the video context to this record.

The interface 201 contains a custom set of tabs (e.g., tabs similar to 220a, 220b, and 220c). The tabs may be defined as a “tabGroup” (e.g., a list of tabs) and can be stored in an .xml file. An exemplary .xml file containing tab information is shown below.

```
<?xml version=“1.0” encoding=“utf-8” ?
<root
<tab
  <title Portal</title
  <url http://www.longwatch.com</url
</tab
<tab
  <title Alarms</title
  <jsload /GetGridJS.cgi</jsload
  <params {“service”:“Process”, “view”: “AlarmHistory”}</params
</tab
</root
```

In the exemplary XML code above, after the standard XML heading line, the XML scheme includes an element called “root”. The root element contains two “tab” sub elements which begin and end with a <tab element. In this example, the XML file generates two tabs with the titles “Portal” and “Alarm History.” The tab element can contain a number of different parameters, such as the exemplary parameters shown in table 1.

TABLE 1

| Element Name | Description |
|---|---|
| title | String to use as the tab title |
| url | Simple web html page to load within a tab. Either url or jsload is |
| | used. The default base path is located on the VCC server |
| | “ . . . Longwatch\User Data\CVE_ROOT”. Otherwise a user must |
| | specify a full url specification. |
| jsload | Contains a url to load a javascript file. This can either be a url to an |
| | EXT JS javascript file (http://extjs.com/) to load into the tab or |
| | Longwatch server cgi specification that will return a js file. |
| params | This element is used to pass parameters for the jsload url. This may |
| | include the format that begins with a ‘{‘ and ends with a ‘}’. In the |
| | example, there are two url parameters for GetGridJS, |
| | service - Name of extension (folder name under |
| | “ . . . \Longwatch\User Data\CVE_ROOT\LUI\EventView\Services” |
| | view - Name of query file to use to access the database located in |
| | the folder specified by service. |

In some examples, a database records an alarm history. The history is generated and stored into a table by an industrial control system (e.g., a Supervisory Control And Data Acquisition or “SCADA” system). Table 2 is an exemplary table that stores alarm history.

TABLE 2

| id | TimeDate | Tag | Description | Status | Priority |
|---|---|---|---|---|---|
| 1 | 5/8/2009 9:54:48 AM | FILLER1_IN | Area 1 - Input Flow 101 | HI | MED |
| 2 | 5/8/2009 9:54:53 AM | FILLER2_OUT | Area 2 - Output Flow 101 | HI | HI |
| 3 | 5/8/2009 9:54:58 AM | TEMP101 | Area 1 - Oven Temperature | LO | LO |
| 4 | 5/8/2009 9:55:03 AM | FILLER2_IN | Area 2 - Input Flow 101 | HI | MED |
| 5 | 5/8/2009 9:55:09 AM | FILLER2_OUT | Area 2 - Out Flow 101 | HI | MED |

In some examples, the above history of alarms is stored in a relational database and is available to be queried by standard programming tools. The database connector tab uses a GRID UI control to display this tabular data. In the above tab example the GetGridJS.CGI call generates a grid view of a relational database table. The params fields (Table 1) specify a specific named query. The combination of “service” and “view” map to a .QRY file that contains the needed connection information, column formatting, and data to video association mapping information. The result of a call to GetGridJS.cgi will be a visual display of the data in the database plus a new column representing that event's camera mapping (represented by a camera icon) as well as a “hot link” where clicking on the date/time value will automatically navigate to that selected time on the video without switching camera views. Thus, the data or camera view can be switched independently.

An interface (such as interface 201) can connect to a database containing a table (e.g., table 2) and can query the data contained within the table. Once the interface retrieves the queried data, the interface can display the data in the event grid 202. Various filtering, sorting, and paging capabilities can then be applied to data displayed in the event grid 202. The “Tag” and “TimeDate” columns within table 2 can be used to play back video based on a tag selected by a user (e.g., FILLER1_IN in table 2) and the time of the alarm (e.g., May 8, 2009 9:54:48 AM in table 8). The status and priority columns contain data that describes a state of the alarm and the priority of the event, respectively.

In order to implement a new tab within interface 201, the .xml file containing the tab data can be edited to contain new tab elements. For instance, an .xml file can be edited to contain the following data.

```
<tab
  <title MyAlarms</title
  <jsload /GetGridJS.cgi</jsload
  <params {“service”:“Process”, “view”: “AlarmHistory”}</params
</tab
```

This .xml file would create a new tab with the title “MyAlarms” and would use the query file “AlarmHistory” to access the database located in a specified folder. An INI text file can then be created called, for example, “AlarmHistory.qry” and can contain the following information.

[QueryService]

ConnectionString=“DSN=ProcessAlarms;”

From=“dbo.AlarmHistory”

PrimaryKey=“id”

DefaultSortBy=“TimeDate DESC”

DatesInUTC=false

TimeDateFieldName=“TimeDate”

The file above specifies a connection to the table dbo.AlarmHistory in the field “From”. The PrimaryKey field is a unique identifier for the row to allow support for paging. The DefaultSortBy field specifies the column to sort. DatesInUTC is a flag indicating if the stored timestamps are in UTC time zone or local time zone. With this information, a user can determine how to convert the timedate columns in a database to a local string. If the flag has a “true” value, dates are stored in GMT. If the flag has a “false” value, the dates are stored in local time zone. The TimeDateFieldName field indicates which column should be used as the primary time/date field for camera playback. Other fields such as ColMap can provide user definable column alias.

Query definition files (“.qry files”) can specify information needed by the external data source definition (e.g., external data source definition 524). The file can be a standard windows .INI file with sections and parameters in each section. One section is called “QueryService.” Other sections allow for the mapping of database column names to header names in the interface. These sections may be called “ColMap_xxx”, where xxx is the name of the database column name to be remapped. In some examples, the default header name in the grid is the name of the database column.

Table 3 represents a list of QueryService section definitions.

TABLE 3

| Name | Description | Possible Values |
|---|---|---|
| ConnectionString | ADO connection string | Some examples: |
| | to the database. This | “DSN=ProcessAlarms” |
| | string is database | ″Provider=sqloledb;Data |
| | provider specific | Source=%COMPUTERNAME%\LO |
| | | NGWATCH;Initial |
| | | Catalog=Longwatch;User |
| | | ID=sa;Password=07161962″ |
| From | Table name or View | Typical Examples: |
| | name that returns a SQL | dbo.AlarmHistory |
| | record set. | |
| PrimaryKey | Name of column used as | This field makes each row unique. It |
| | the primary key | is used during paging. |
| DefaultSortBy | When data is selected | Example: TimeDate DESC |
| | from the database this | |
| | field specifies the column | |
| | name and sort ORDER | |
| DatesInUTC | Used to define the time | true - will assume time is UTC and |
| | zone of the time and date | will convert to the local time of the |
| | field. The system will | VCC. |
| | always convert to local | false - assumes the time in the |
| | time. | database is local time. |
| TimeDateFieldName | Name of the database | |
| | column that identifies the | |
| | key time for starting of a | |
| | video playback. | |
| AssociationExtDataName | This is the name of the | Example: “Ext1” |
| | Longwatch Extended | Either “Ext(n)” where n = 1 . . . 5, or the |
| | Field used to associate a | the user defined name of the |
| | database field to a | extended field (see VCC config tab) |
| | camera. (See Camera | may be used |
| | association) | Example: “Equipment” |
| AssociationDBField | Name of one of the | Example: “Tag” |
| | database columns use to | |
| | perform camera | |
| | association. | |
| Columns | A comma separated | “id, TimeDate, Tag” |
| | string of database | |
| | columns to be shown in | |
| | the UI. Note: if this | |
| | column is not defined | |
| | than all of the columns | |
| | are shown. | |
| DefaultColWidth | Number of pixels used as | |
| | the default width for | |
| | columns if not specified | |
| | in a ColMap. | |

The AssociationDBField and AssociationExtDataName provide the means for the server to map individual rows into cameras. The AssociationDBField tells the system which column in the data set to match, and the AssociationExtDataName is the name of one of the extended data columns in the Longwatch camera database. When a row is processed, the server will take the data from the column named in the AssociatedDBField and try to “match” it to one or more cameras. The matching algorithm provides a way to group more than one camera to a specific event by specifying a list of strings separated by comma that represent the patterns to match against.

Custom user interfaces can also be created in a tab. For example, if a user wants to display data in a grid (e.g., event grid 202) with specific display options that are not included in the default template, an ExtJs javascript can be created and loaded into a tab. Examples of these javascripts include scripts that handle loading and interacting with a chart object as well scripts that access an alarm database and provides custom filtering.

In order to allow created javascript code to interact with the playback engine 518, the javascript code can access a global javascript object called “AppManager.” Table 4 below represents a list of AppManager definitions and functions.

TABLE 4

| Function | Description |
|---|---|
| AppManager.LinkTimeDate (Source) | This function is used to tell the |
| | playback system that an object wants |
| | to be in control of the playback time. |
| | This method can be called before |
| | making one or more calls to |
| | UpdateEventTime( ) (see below). The |
| | source parameter specified here is the |
| | same as the one passed to |
| | UpdateEventTime( ). In some |
| | examples, the source parameter is a |
| | simple string that uniquely identifies a |
| | plug-in. |
| AppManager.GetLinkTimeDate ( ) | Returns the current source of the time |
| | date changes. If the user is controlling |
| | the time date with the video controls |
| | (play mode) this will return “video”. |
| | The Trend chart returns “Trend”. |
| AppManager.ReleaseTimeDate (Source) | The system can be designed to have |
| | multiple potential “controller” of the |
| | global time of interest. LinkTimeDate |
| | and ReleaseTimeDate provide a means |
| | for the different controller to grab |
| | control of the global time date and |
| | change it. All others would then be |
| | slaves and respond to that controller's |
| | changes. Controllers are video slider, |
| | pen chart slider, event row select. |
| | These UI events grab the global time |
| | date and update it. |
| AppManager.UpdateEventTime (EventTime, Source) | This function is used to set the |
| | playback time of the currently selected |
| | cameras. The EventTime parameter is |
| | a Date object containing the time to |
| | seek to. The Source parameter is a |
| | string identifier of the source of the |
| | event. This parameter can be used to |
| | identify the originating source of the |
| | event. |
| AppManager.PlayVideo(EventTime, camList) | Seek the video to the EventTime for |
| | the list of cameras specified in |
| | camList. CamList may have the |
| | following format. |
| | UnitName:Cam#,UnitName:Cam# |
| | Example: “LVE1:0,LVE2:1” means |
| | playback camera 0 on LVE1 and |
| | camera 1 on LVE2. Note: when a |
| | camera association column is |
| | generated for a row of a data set the |
| | value of the column is in the camList. |
| AppManager.getCurrentAccessMode( ) | Returns the current access mode of the |
| | video system. |
| TabManager.Register (obj) | This function can be used to register |
| Called with the access mode changes (0-Guard, 1-Live, | with the system an object that will be |
| 2-DVR, 3-Event) | called when the user changes |
| this.loadChart = function(chartName) | something in the user interface. This |
| Called when a trend chart is loaded (could be on a | is used to cause a tab to respond to |
| View load) | playback time or access mode changes. |
| | The “obj” that is passed is assumed to |
| | be a javascript object with the |
| | following functions: |
| | this.UpdateEventTime = |
| | function(EventTime, Source) |
| | Called with the PlayBack time |
| | changes, Source is a string identifier of |
| | the component that initiated the |
| | change. |
| | this.NextEvent = function(acMode) |
| | Passes in the current access mode |
| | when called |
| | this.PrevEvent = function(acMode) |
| | Passing in the current access mode |
| | when called |
| | this.setAccessMode=function(acMode) |

FIG. 7 is an exemplary screenshot 700 of the interface 201. Trend chart 702 is located in the upper region of the screenshot, and three video clips 704a-c are being shown in the video window 706 located at the bottom of the screenshot. A time cursor 708 has selected a time 4:46:19 to display the actual trend values (32.04 and −8.38 respectively for the two graph lines 712 and 714). The video window 706 is playing back three video clips that begin at time 16:46:19 for “Cam2,” “Camera4” and “Camera5” respectively. Camera selection window 710 allows a user to select which video clips to display in video window 706. In this example, video is being displayed that is associated with the cameras Cam2, Camera4, and Camera 5.

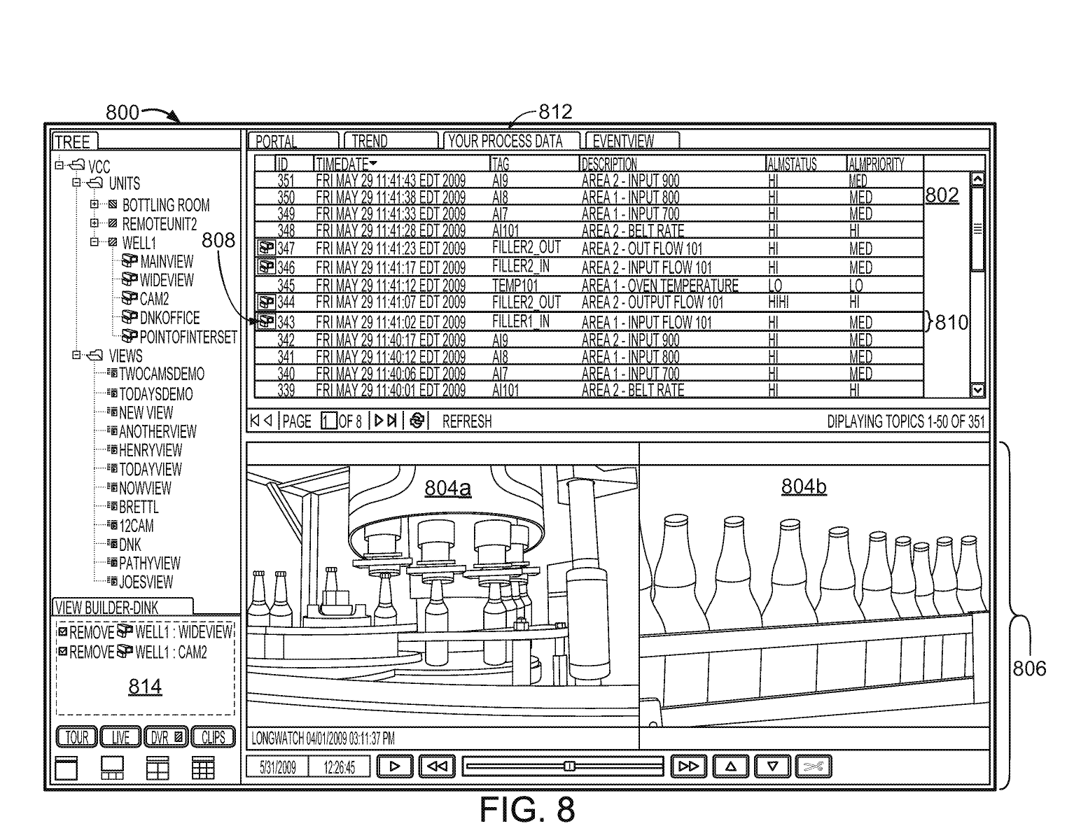

FIG. 8 is also an exemplary screenshot 800 of the interface 201. In this example, the Process Tab 812 is selected. With the Process Tab selected, the interface 201 shows process data in a process data window 802. The process data is contained in process messages (e.g., process message 810), and could be data that was extracted from one or more external databases. The messages can then be parsed and mapped to one or more cameras. If a message has been mapped to a camera (e.g., if a “relationship” exists between a message and a camera), a camera icon 808 can be displayed near the message 810. Clicking on a message (e.g., with a cursor controlled by a mouse) that has an associated camera icon will cause the interface to display video clips (e.g., video clips 804a and 804b) in a video window 806 from the associated camera(s) at a time contained within the message. Camera selection window 814 allows a user to select which video clips to display in video window 806. In this example, video is being displayed that is associated with the cameras “Cam2,” and “WideView.”

Other implementations are within the scope of the following claims.

For example, A wide variety of other implementations are possible, using dedicated or general purpose hardware, software, firmware, and combinations of them, public domain or proprietary operating systems and software platforms, and public domain or proprietary network and communication facilities.

A wide variety of audio-visual capture devices may be used, not limited to video devices. For example, cameras that capture still photographs could be used, as well as microphones that capture audio data.

The remote location and the central location need not be in separate buildings; the terms remote and central are meant to apply broadly to any two locations that are connected, for example, by a low bandwidth communication network.

User interfaces of all types may be used as well, including interfaces on desktop, laptop, notebook, and handheld platforms, among others. The system may be directly integrated into other proprietary or public domain control, monitoring, and reporting systems, including, for example, the Intellution-brand or Wonderware brand or other human machine interface using available drivers and PLC protocols. The system described above provides a capability to record from a variety of cameras into a DVR file and (among other things) to automatically associate records in a database with particular locations in the recorded video data. This allows the user to later scroll through the database and easily view a video recording of what was happening within the process at the time these events were entered into the database.

Much of the discussion above describes using audio-visual capture devices to capture audio, video, or images in real time of one or more physical aspects of the operation of a process being controlled, or a system being managed by a factory automation application, and to synchronize the display of events and captured video to aid the operator and for other purposes.

This approach can also include capture of audio, video, or images in real time that are not audio, video, or images of the operation of the process itself but rather of other things that relate to the process. For example, audio, video, or images (we sometimes refer to these simply as audio-visual or audio-video content) of the graphical user interface displayed on a monitor of a factory automation application can be captured in real time while the process is being controlled, and can be associated with events occurring in the process, in the same way as described above. Such user console audio-visual capture can show exactly what the operator was shown, heard, said, and did at any point during the process (or during a simulation of the process in the case of a trainer or simulator). The playback of the console audio-video content can be done at the same time as the playback of factory automation audio-video content, as explained below.

Such captured audio-visual content can be very helpful in analyzing the efficiency and effectiveness of the user interface, of the operator, or of a combination of the two. It can also be helpful in evaluating failures of the interface or the operator or the process or combinations of them, and in training, review, and critique of operators and others involved in factory automation.

As shown in FIG. 9, in some implementations, in a factory automation context 901 the video or audio or image information (or a combination of them) 902 that represents what the operator 904 was shown, heard, said, or did (or combinations of them) through a console or other human machine interface 905 can be recorded (we sometimes say captured) by a console recorder 906 that includes four software elements as follows. (In the example explained below, we refer to video capture simply for illustration, but the same principles can be applied to recording or capture of images, series of images, audio, and combinations of them or any kind of audio-video content.)

A capture element 908 captures the continually changing (or not changing) audio-video console content, for example, the user interface being shown on a computer display (in this case the console display of the user or operator) and provides the captured content to a video (or other content) recorder 910.

The recorder (which we also sometimes refer to as an archive) records and archives the captured computer display information (or other audio-video content) as, for example, video data, and also can provide forwarding services to forward the captured video in real time to a computer display 912 to permit “live” viewing. In the latter case, the computer display 912 could be a different display from the console of the operator, or in some cases could be the operator's console.

Video stored in the archive (which in some examples is disk-based) can be retrieved from the archive for a wide variety of uses by a retrieval system 911.

One typical use would be to provide the video to a display system 914 (which we sometimes call a viewer) that implements an interactive user interface 915 to receive command inputs, display the video and other information, and permit a user (who may or may not be the console operator) to annotate, for example, the video.

The console recorder—whether in the form described above or in any other of a wide variety of forms—has a broad range of applications including the following:

(a) display of sensor-based values (numbers, bar graphs, color changes, etc.) that are presented to an operator in a human-machine-interface in a factory automation system,

(b) correlation of the time moments and time periods of the recorded video with alarm messages, data trends, and other data sources in the factory automation system, to improve decision support in the factory automation environment,

(c) playback of the display recording (or parts of it) to the operator (statuses, messages, and values, for example) and the operator's actions (as noted, for example, by mouse cursor movements and information displayed from keystrokes or other command entries and any other of a wide variety of sensors that capture information the actions of the operator) to aid in troubleshooting.

(d) use, among other things, of the methods in (c) to help train operators in a review of actual plant conditions that occurred, or in a review of activities occurring in a simulator or training session.

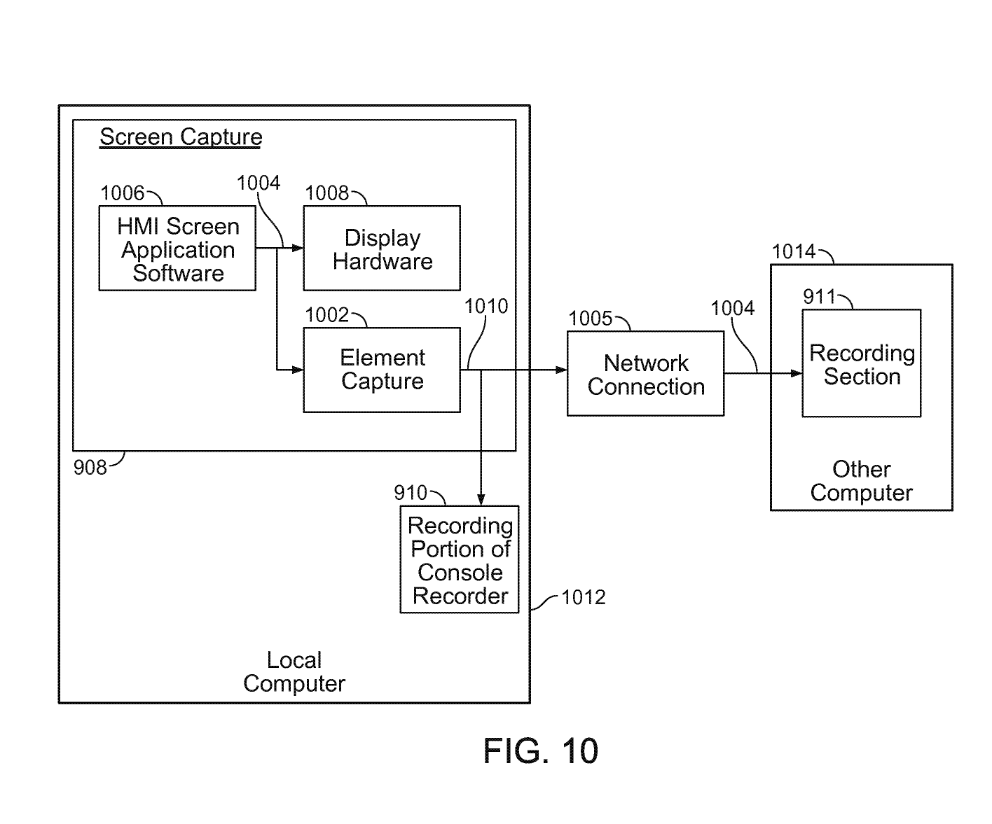

As shown in FIG. 10, the capture portion 908 of the console recorder, in some implementations, includes a small software element (e.g., a software service) 1002 that captures display information 1004, for example, as other applications 1006 send that information to display hardware 1008 for presentation. This captured display information is compressed by the capture element and converted into a video stream 1010 that is sent to the recording portion 911 of the console recorder. The sending process can be done locally (that is in the location where both the capture and recording portions are resident in a local computer 1012), or the video stream 1010 can be sent from the local computer containing the capture portion to a different computer 1014 containing the recording portion through a network connection 1005, using a standard TCP/IP protocol, as one example.

The capture element thus siphons display data as it passes from an application to the display hardware. The capture element 1012 can be turned on or turned off using a program command in the factory automation application 1006 (or can be triggered by a person). This enables the console user to actively manage privacy (recording of what a person does at the screen), as well as the usage of CPU, network, and disk resources. When the capture element is active, it captures all information on the screen as well as movement of the displayed mouse cursor (if present); the capture is not limited to particular windows or area of the screen, although limiting the capture that way could be possible.

Video screen capture technology is found in, for example, PCAnywhere, VNC, and Microsoft Remote Desktop, and uses well-documented Windows system calls to take periodic snapshots of the screen as a bitmap and DirectX calls to create a DirectX capture filter that provides this bitmap as a video stream 1010.

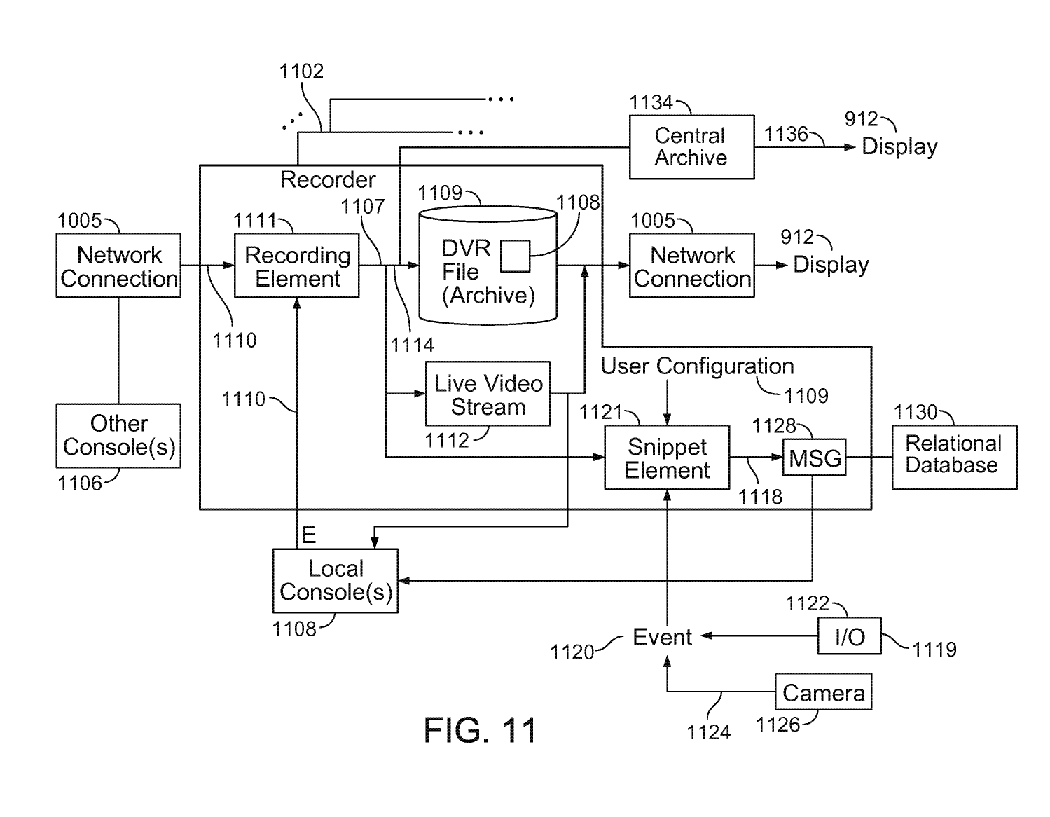

As shown in FIG. 11, the recording section 910 (of which there may be many 1102 in a particular factory automation system) retrieves real time console video 1110 at a recording element(s) 1111 from local or other console or consoles 1106, 1108 for which recorded video is being requested.

In some implementations, the recording portion stores the audio-video content 1107 (including any information on the graphic display, for example, all windows displayed, as well as mouse cursor movements) in a standard video file format. The video files 1148 are named according to the time of recording, for example, to make video retrieval easier.

When the video stream 1110 arrives at the recording system from the capture element, it is processed to provide three different streams for use as follows. A live video stream 1112 is provided that can be displayed in real time. A digital video recorder (DVR) stream 1114 is stored in digital video recorder (DVR) files 1108 in a DVR file archive 1109 for later retrieval and viewing. And a clip stream 1118 is formed, by a snippet element 1121, that is a snippet of automatically-edited video that is associated with an event 1120 in the factory automation system.

In the case of the clip stream, the user can configure 1109 the length of the clip that appears before and after the event. For example, the user might want the clip to show three seconds of video before the event and seven seconds after the event, for a total clip length of ten seconds. The event can be defined either by external data 1119 brought into the recording software through input/output hardware 1122 of the factory automation system, program-commanded using inter-program communications, or by a video analytics message 1124 sent from the camera or other capture device 1126 itself. When the event occurs, an event message 1128 is created with the clip 1118 attached. These event messages are stored in a relational database 1130 and are also displayed, for example, in a list, by the display software on the user's console. When the user clicks the mouse on an event message in such a list, the clip 1118 is retrieved from the database and automatically displayed.

In some implementations, the video from the recording elements may also be uploaded to a centralized archive 1134 for security and management purposes. In this case, the display element(s) will retrieve archived video 1136 from the centralized archive rather than from the distributed recording element(s). As shown in FIG. 21, When a client application, either a video viewer 2102 or a human machine interface (HMI) application 2103 that is exposed, say, as an embedded active control for viewing video, asks for video through the network or a co-located console 2104, a playback manager 2106 uses time, date, and unit information 2107 from the SQL database 2108 as parameters to fetch the video segment from the recorded video archive 2110. If the video is not located in the centralized archive, the playback manager uses the network to attempt to locate it in the distributed archives among the local consoles or other systems, for example.

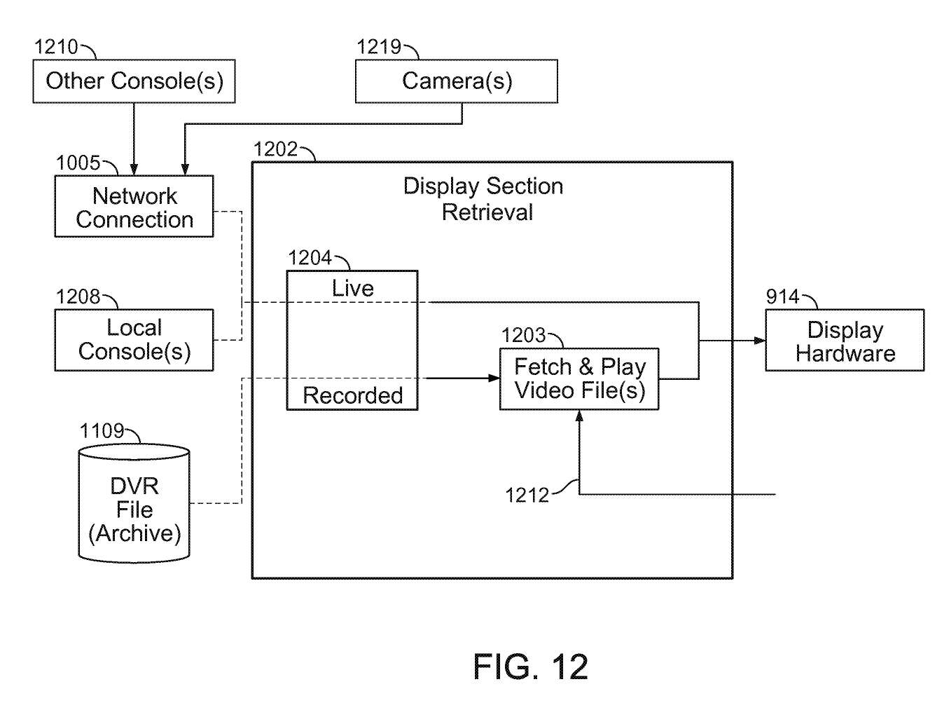

As shown in FIG. 12, in the retrieval section 1202, a fetch and play element 1203 retrieves video 1204 (either live or archived). The content is retrieved from the local console(s) 1208 or other console(s) 1210 through the network connection 1005 (in the case of live display), or from a DVR file archive 1109 for display of recorded content. The content is performed on, for example, display hardware 1209, for a user. Which content is performed for the user can be determined by start time/date and console or camera identification 1212 provided by the user or automatically.

Thus, in some implementations, the retrieval system 1202 includes a stand-alone, thin-client user interface (which we also sometimes call a retrieval program) 1203 for retrieving, managing and viewing video in various formats and states. The user can view both recorded console video (that is, the video captured from the console display) as well as recorded camera video (that is video captured by a camera or multiple cameras 1219 of aspects of the factory or process that is being controlled by the factory automation system).

The retrieval program provides several ways to retrieve a desired recorded video, including (a) mouse clicking on a displayed event message that has a clip attached, (b) placing the display system in a DVR mode and entering the desired date and time (which causes the retrieval system to retrieve the corresponding stored video file—based on date and hour—and locate the selected position within that file—according to the minute, or (c) placing the display system in DVR mode and clicking on a displayed event or alarm message that does not have a clip attached (which causes the display system to fetch the appropriate stored file based on the date and time of the event message).

The retrieval program is useful for demonstrations and for training in which particular video files are played back for an operator.

As shown in FIG. 14, for purposes of controlling the playback of captured video, the user interface transport control 1402 (which appears as part of windows and sub-windows displayed on the console) shows the time and date 1406 of the requested video to be played back, a toggling pause and play control 1408, skip forward 1412 and skip backward 1414 controls, and a shuttle control 1416 that can be dragged left or right to move to a different place in the video segment. In addition an up and down arrow control 1418 allows the user to move up and down in a displayed list of available event clips. A bookmark control 1420 enables a user to insert a manual event in the list of clips to indicate a content segment of interest. A suspend/resume recording control 1422 allows a user to suspend and resume recording of content.

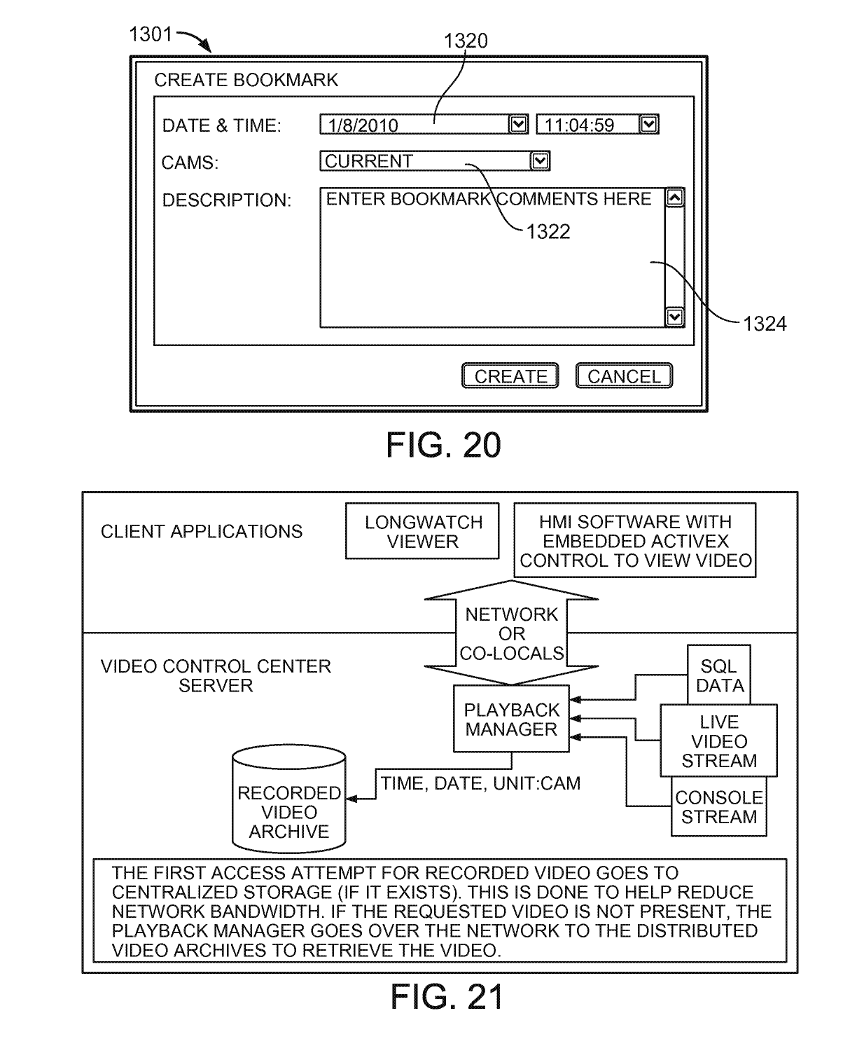

As shown in FIG. 13, the user can annotate a video event message list 1302 of the user interface using the bookmark button 1420. (This can also be accomplished by a program call from another application.) Pressing the bookmark button inserts an event entry 1306 in the event list of the factory automation system. As shown in FIG. 20, the user can (in a dialog 1301) provide information related to the bookmark, including the date and time 1320 (defaulting to the time when the button click occurs), the video panel associated with the bookmark 1322, and a free-form text description 1324. This information, or some of it, is included in the displayed list shown in FIG. 13. The icon 1304 used for the entry gives the user a visual indication that the entry is a bookmark rather than a system generated event. The user can also sort the event list to show only bookmark entries. When the user clicks on the bookmark entry, the system automatically retrieves the desired video.

Note that a single set of controls of FIG. 14 can be used to govern synchronized playback of multiple panels of video or other content. The time and date with respect to which content is displayed in multiple panels by the retrieval program, is coordinated so that, for example, a camera view of activity on a factory floor is synchronized with the screen capture of what the user was seeing and doing.

Therefore, as described, the console display video stream be created, used, and treated in much the same way as the camera-generated video data of the process described earlier. For example, all the associations and features of the system described earlier are then available for this console video stream.

As noted, the stored screen video stream can provide additional information for later analysis of what the operator was viewing and what the operator was doing during any period of interest. This analysis can be useful in evaluating the performance of the operator, in improving the process, and improving the process control application that the user is working with, among other things.

For example, one use of the screen captured video would be to record the screen or screens that were actually used by an operator to control a process. If an event occurs in the process, the user or another party can review not only the video of the process itself, the states of the process, and events that have occurred, but also, for an event or a state, the screens (including data) that were presented to the operator and the actions the operator took in response to event or state. A wide variety of other uses can be made of the screen captured video, alone or together with other information about the process or the process control application.

As explained earlier, there are various ways to implement this feature. In some approaches, the video data of the screen is captured on the local computer (the one running the application discussed earlier). In some approaches, the video data captures the screen of a separate (target) computer (e.g., one running a process operator display application).

In some implementations, a remote version running at one location in the system installs a small service on the target computer (e.g., console) which uses the same DirectX code as above. This service creates the video stream and then compresses the video (using a Microsoft algorithm specifically designed to compress screen images) and transfers the stream across an IP network to the computer running the video historian discussed earlier. The technology used to capture and transfer the screen image is very much like the technology used by the other products mentioned above (PCAnywhere, VNC, etc). The technology used to record the stream to a file can be AVI file technology.

The display video window presents itself as a Microsoft ActiveX control. This control can be presented either in the display section (in a browser-based user interface) or in the user's own display software. Like the event window described above, the video window's behavior can be integrated with the program that contains it using Visual BASIC.

Mapping a camera to data includes four functions: naming the SQL data fields, identifying the location and format of the SQL data fields, defining what text to look for in the SQL data fields, and displaying the SQL data fields with an icon indicating that there is video associated with the message.

The system stores all such configuration information in a relational database. Each event and alarm message (representing a system event, a hardware-sensed event, a camera analytics event, a software-triggered event, or a video bookmark) can have up to five SQL tags. These tags aid the user in categorizing and annotating the event message entries in the database.

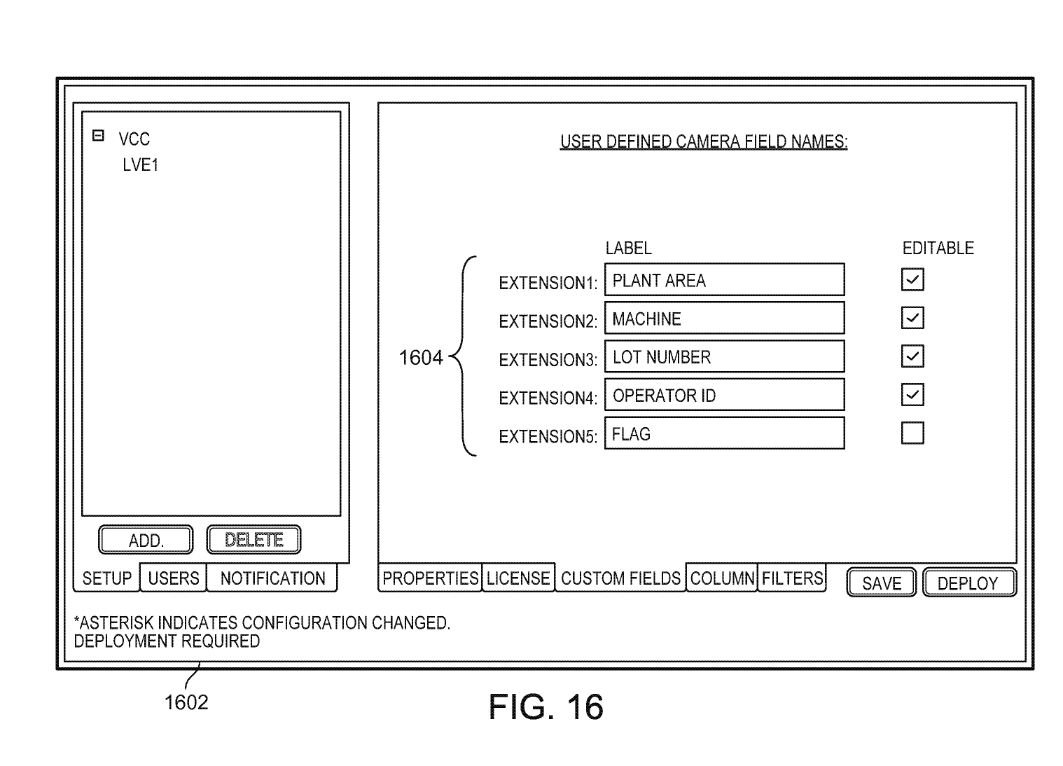

The user configures elements of the database using interactive, fill-in-the-blanks forms that are presented through a web browser. As shown in FIG. 16, a dialog 1602 enables a user to give each of these five SQL tags (called extensions in the dialog) 1604 a name that has descriptive meaning to the user. The dialog 1602 is displayed when the user is configuring a video control center in the video display system.

During operation, the contents of these fields can be changed either through the user display or through inter-program commands, using protocols including OPC (OLE for Process Control), SQL (structured query language), or ODBC (open data base connectivity).

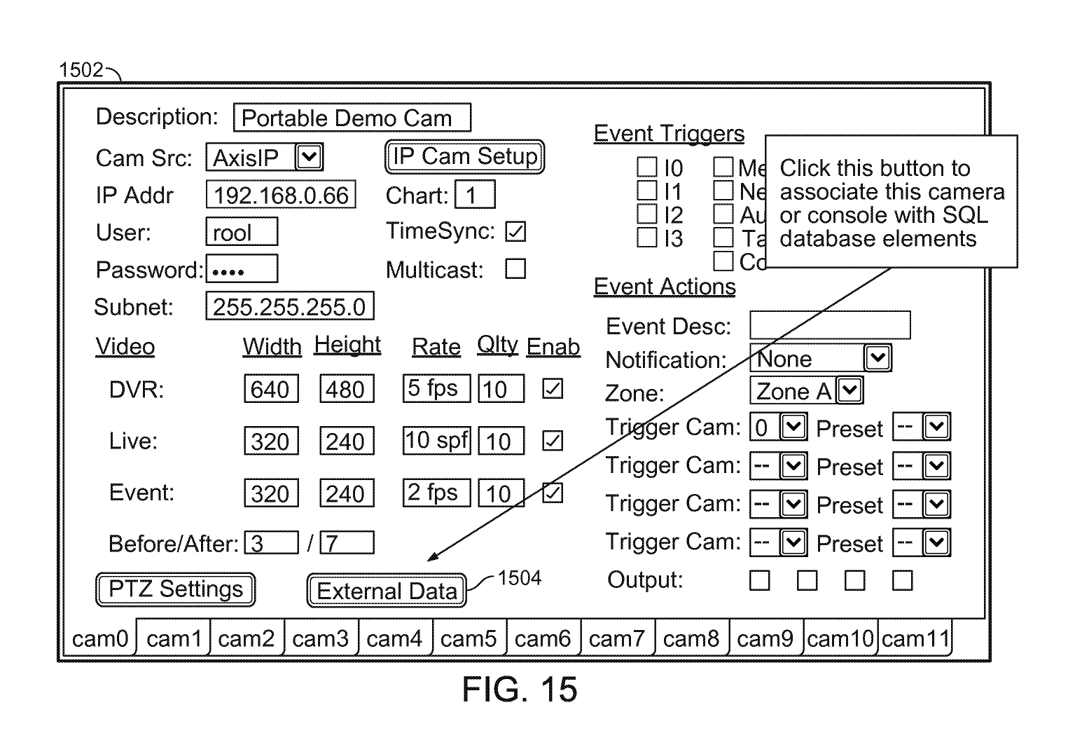

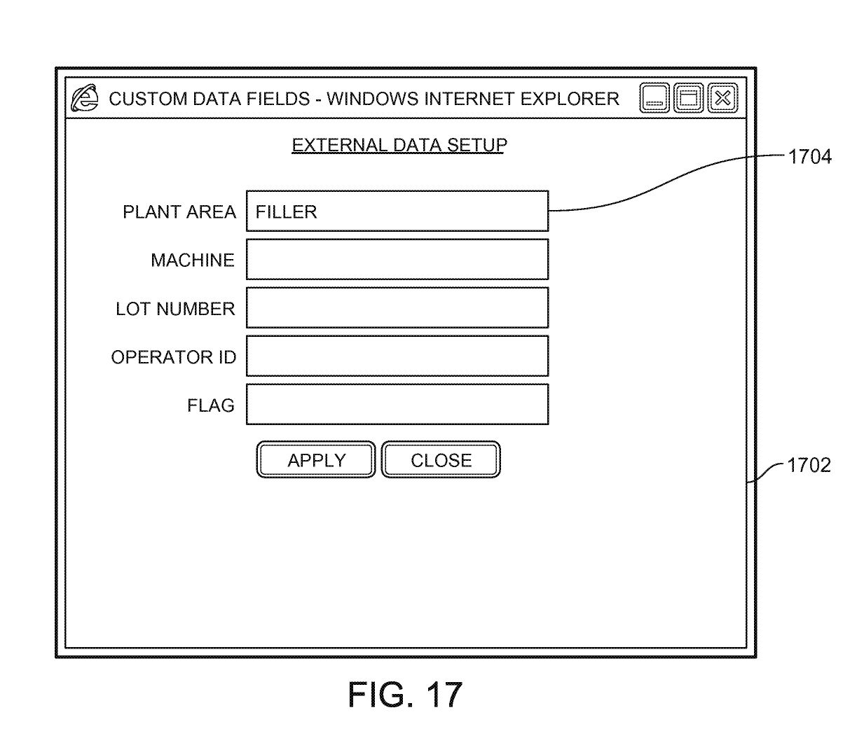

After the user has given the extension fields useful names in the dialog 1602, the user can specify the text to look for. In some implementations, this is done on a per-camera (or per-console) basis in the configuration screen of FIG. 15. Because the console recorder handles recorded screen images just like other video sources—such as cameras observing the factory automation devices—the console recorder video can be mapped automatically to messages contained in external SQL databases. In the user dialog 1502, the user can invoke the control 1504 to achieve this. This function enables the user to command the system to automatically seek and fetch recorded video from a particular camera/console (the one selected in the other portions of the dialog) at a particular time. The result is much faster access to the video of interest, and the ability to associate a manufacturing or other context (other than simply time and date) with the video. When the user clicks on the external data button, another dialog 1702, shown in FIG. 17, enables a user to specify the text 1704 for each of the SQL fields.

In a case in which a camera and a machine, both in fixed positions, are being tracked, the user's system layout (both physical and electrical) can specify the association of that camera with that machine.

The display system connects to the user's database using standard Microsoft database connectivity commands. A database description table tells the display system how to interpret the database; namely, which user fields are located in which columns and what in what format (for example, text.)

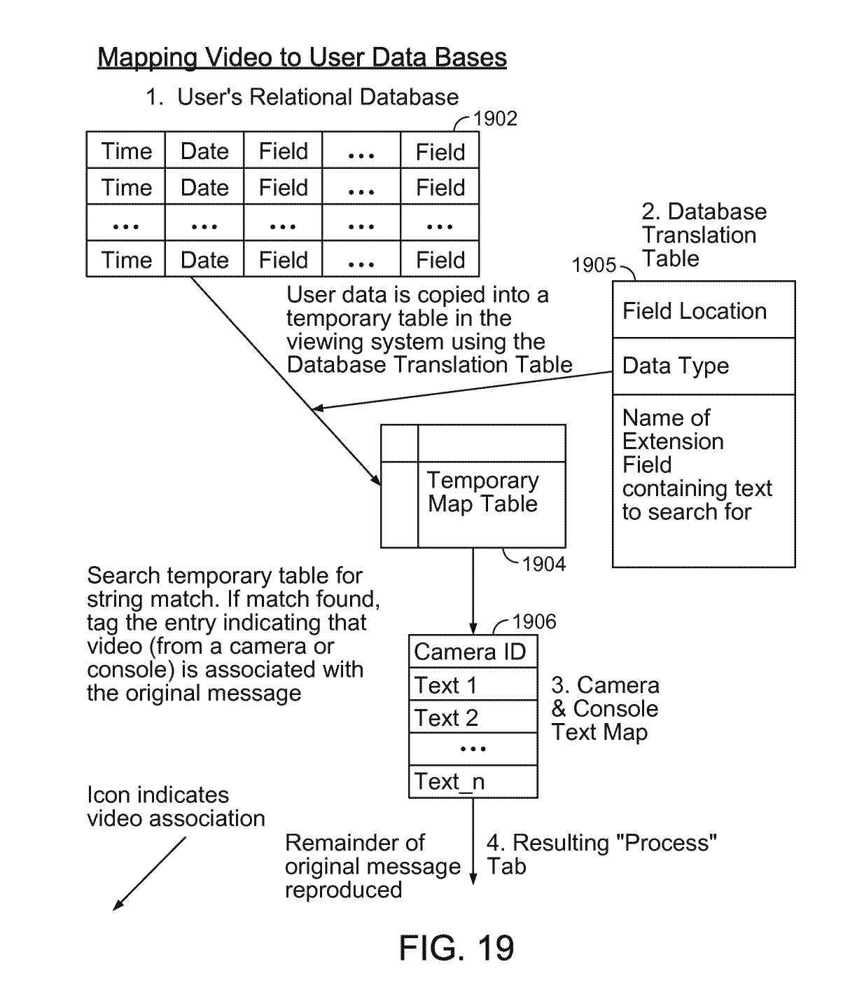

As shown in FIG. 19, as each SQL message 1910 is copied from the user's database 1902 to a temporary table 1904 using the data translation table 1905, the display system checks to see if the selected strings are found in the camera map table 1906. If a match is found, an icon is prefixed to the message 1908 as it is copied into the table that forms the process tab display. In some implementations, up to four consoles and/or cameras can be associated with any single entry in the process tab listing.

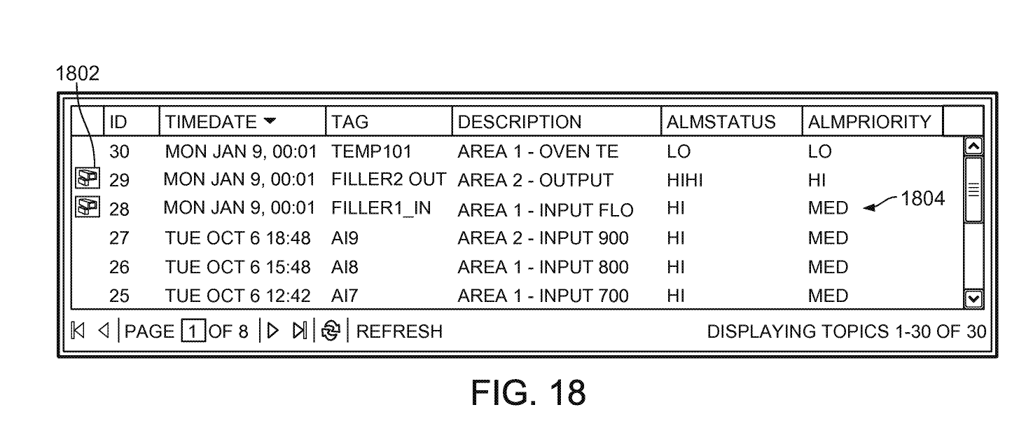

In the example above, if the SQL database 1902 sends a message, such as “Sep. 30, 2009 14:15:04 CARTONER JAM FILLER2” the camera-to-data mapper extracts the SQL message and separates it according to the definitions given by the user. In this case, the user indicates which column is associated with PLANT AREA. After the mapper extracts the text from that column, it determines that there is a string match for the word FILLER. As shown in FIG. 18, because this string has been assigned to this camera, the camera-data mapper will place an icon 1802 in the message 1804 indicating that a match has been found.

When the user clicks on the icon, the playback manager will automatically access the stored video for that particular camera (or console, or set of cameras and consoles) at that date and time. In FIG. 18, when the user clicks on a line containing an icon in the process tab, the video associated with the corresponding console(s) and/or camera(s) is fetched according to the date and time in the message. The resulting video is displayed in one to four video panels in the display.

Note that this event list window can be present either in the browser-based, independent user interface or in a user-built display. The window is placed in a user display using Microsoft ActiveX controls. Integrating the behavior of the event list window Active X control with the behavior of the user display (for example, a plant diagram or a user-written HTML browser page) is performed with “scripts” of Microsoft code (e.g. Visual BASIC.)

The display system enables 912 the user to see one or many panels of video, each panel containing video from either consoles (computer displays) or cameras or video from stored files. Video from stored files is displayed in a manner that simulates an actual camera.

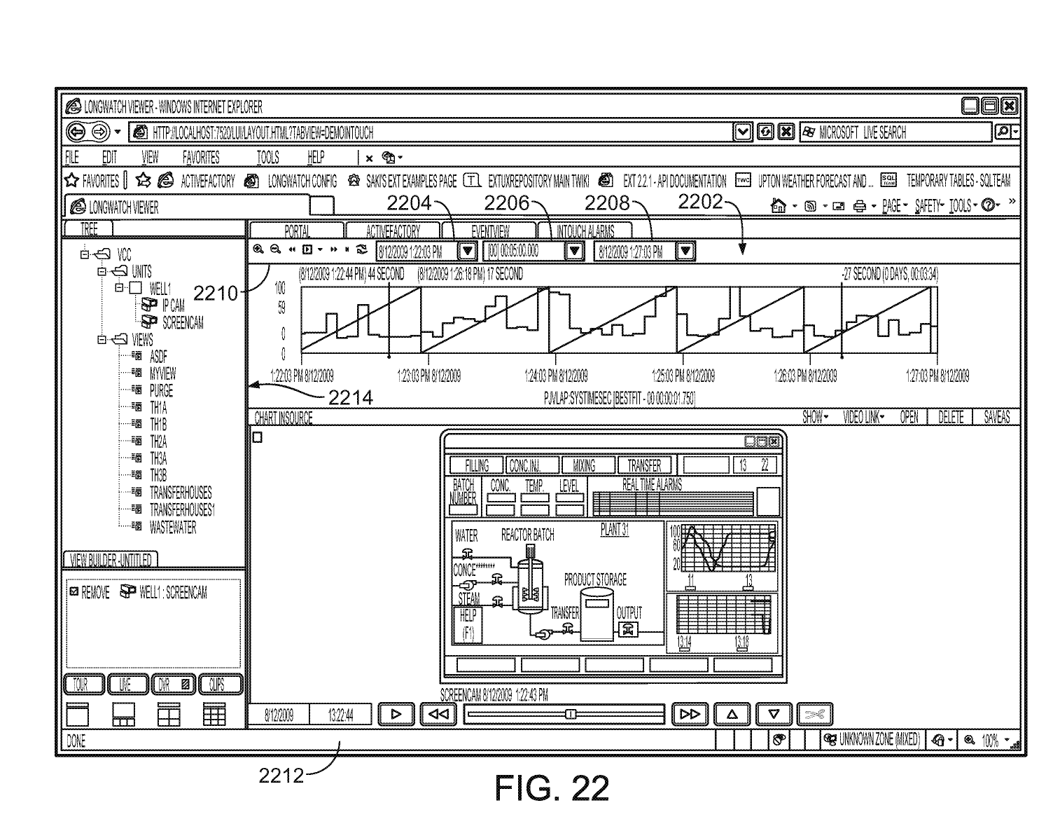

FIGS. 22 through 25 illustrate console display screens associated with the system described above.

FIG. 22 shows a screen of a factory automation viewer. The right hand part of the screen is split horizontally to provide an upper window 2202 that in this case is illustrating a time sequence of a parameter value associated with factory automation (this view is selected by the tab ActiveFactory among the tabs above the window). The time segment is selected using the text entry boxes 2204, 2206, and 2208, and the playback of the data is controlled by the transport controls 2210.

The bottom half of the screen contains a window 2212 that in this case plays back a console recorded video that is synchronized in time with the data shown in the upper window. The choice of which view to show in the bottom screen is made in the tree panel 2214 to the left. In this case, it is the ScreenCam for Well1. The tab underneath the tree panel, called view builder, enables the user to control what is seen in the windows to the right. In this case, the only video that is displayed in the bottom window is the Well1 Screen cam. However, up to four videos can be displayed at once. The user adds additional video sources by selecting them in the tree panel, which places them in the list in the view builder and includes them in the window to the right. Beneath the view builder list are four buttons that enable the user to choose among clips, DVR, live video, and a tour. Beneath those buttons are four possible arrangements of the windows as they appear at the right.

The transport controls at the bottom of the video playback window have the functions described before, and all of the displayed data and videos playback in synchronization as explained before.

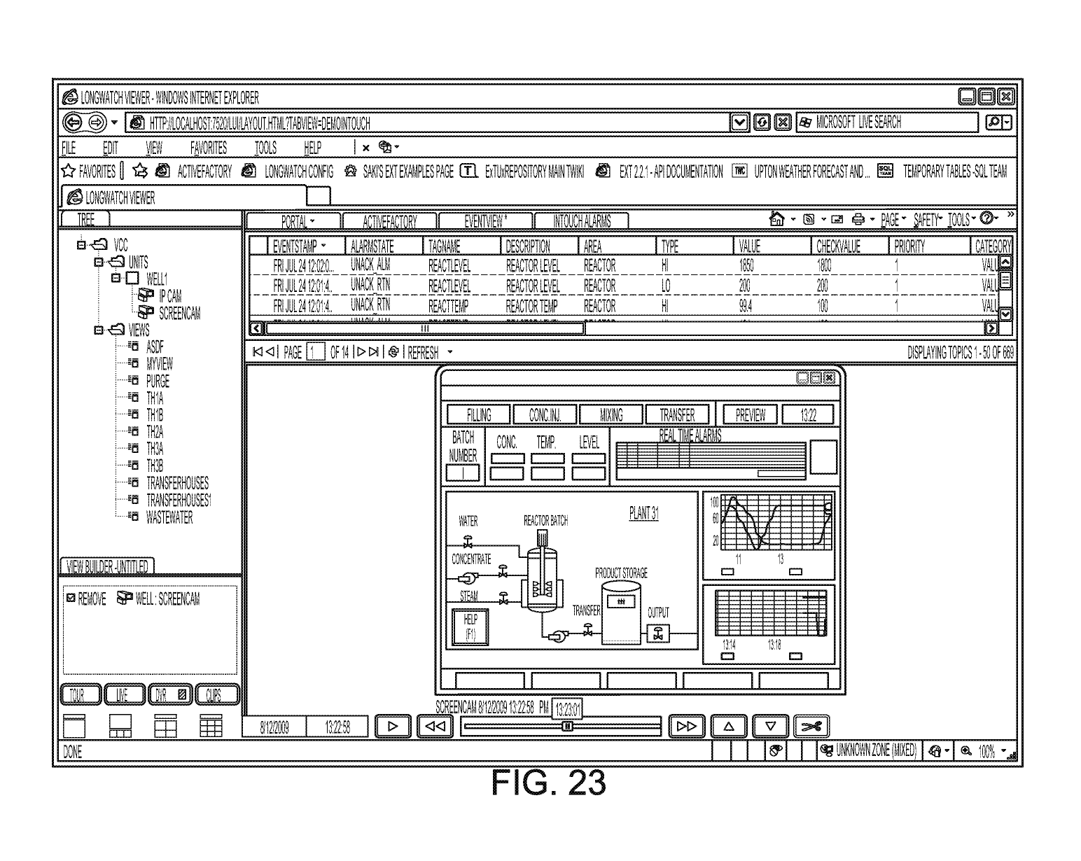

In FIG. 23, instead of the upper window displaying active factory data histories, the upper window here displays alarms (because the tab titled in touch alarms is invoked). Here the alarm history is recounted. When a user invokes one of the items on the alarm list by clicking it, the screen cam below will display, synchronously, whichever screen capture or other videos have been selected in view builder.

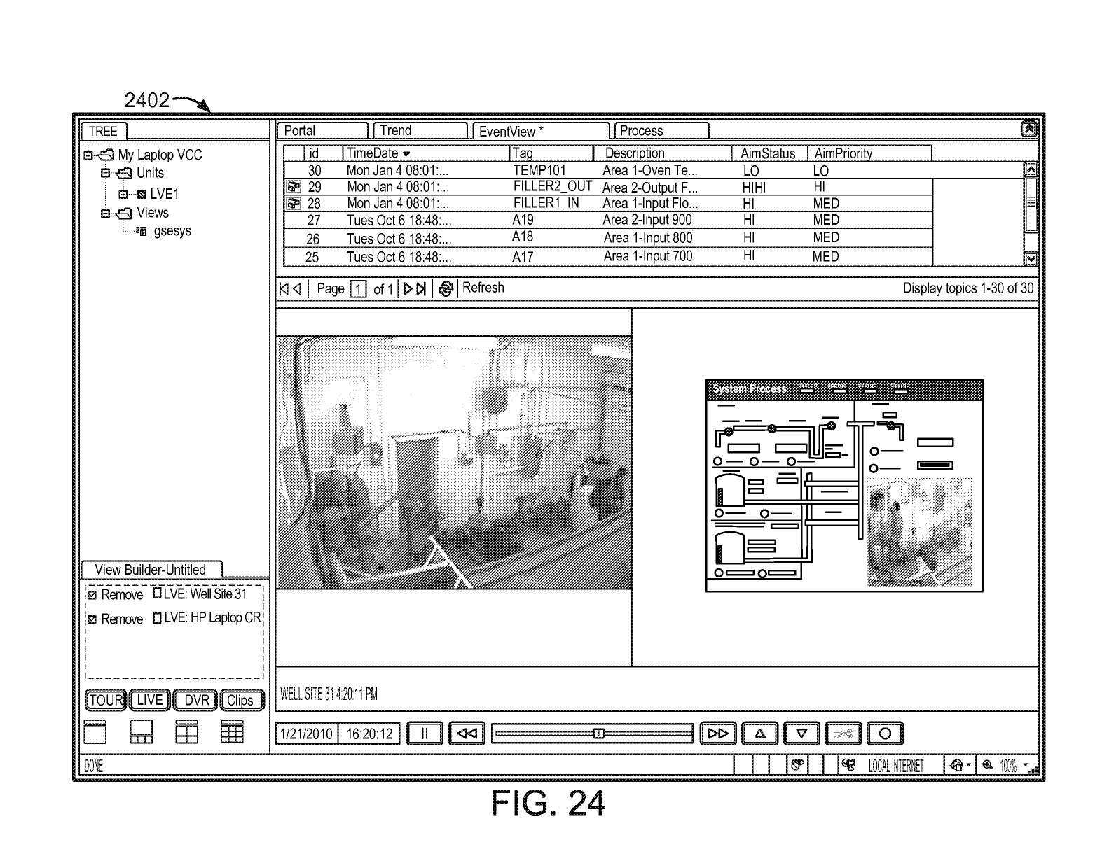

FIG. 24 illustrates the screen that is available to a user who has invoked the process tab 2402. In this view, the view builder indicates that two sources are to be shown in two sub-windows. One of the views, on the left, is of a local video for a factory camera the video of which is being fed to a local console. On the right side is a sub window that is displaying the screen capture for the local console, including the factory automation control information, and (in the lower right) the live streaming video.

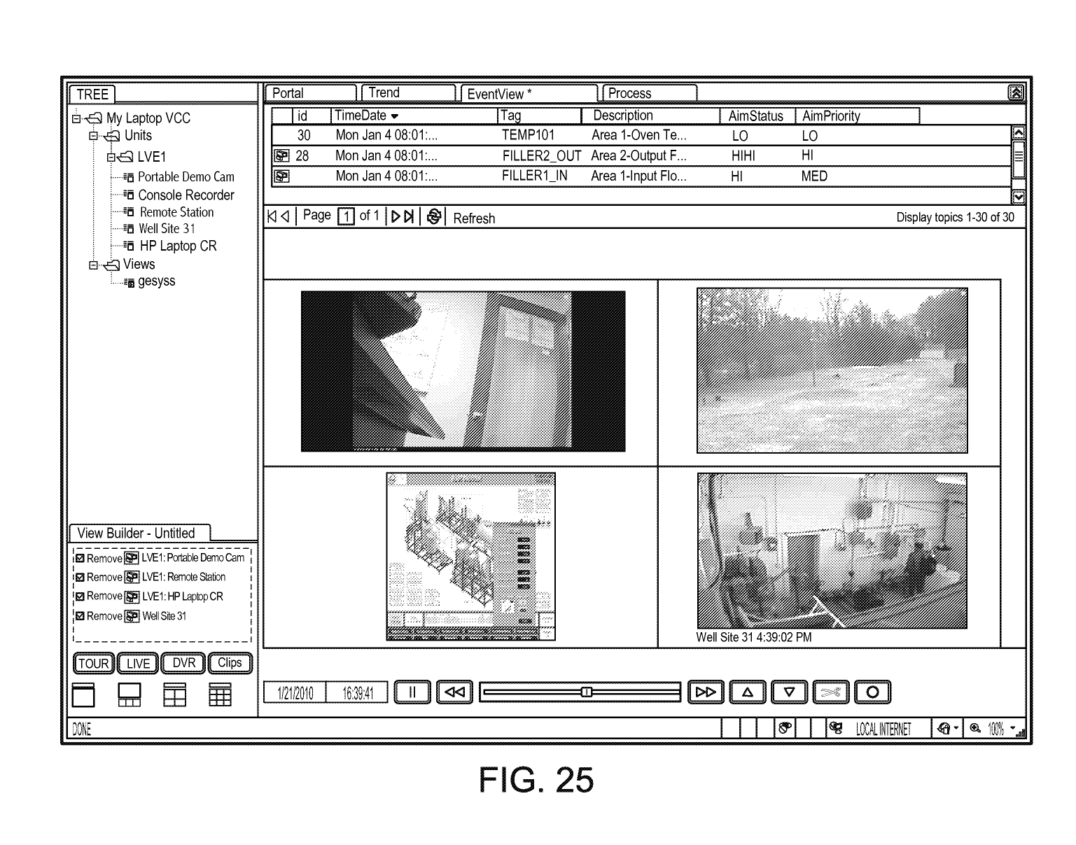

FIG. 25 is similar to FIG. 24 but four sub-windows are shown. The top left sub window shows the live feed from a local camera. The lower right sub window shows another live feed from a different video camera. The lower left screen shows a live recording being done of the screen of a local console (the green dot at the upper right corner of that sub window indicates that a recording is being made).

An example application of this function would be in a control room that is split into two halves: one half responsible for the “compounding” portion of the factory; the other half responsible for the “packaging” portion of the factory. Assume that there is an operator display dedicated to each half of the factory, and each of the displays is recorded using the console recorder discussed above. Suppose that a third-party machine tracking system detects that one of the packaging machines has run out of packages. The tracking system creates a message in its database including the following information: <date><time><machine number><status><descriptor>.

The camera mapping function, in combination with the multi-camera display of the display program, would enable the user to see, for example, two video windows: one showing recorded video from a camera mounted near the specific packaging machine that had the problem, and one window showing what was on the operator's console display at the same time. The user can then press the play button on the transport control to view both videos synchronously; the user can also rewind or fast-forward as desired and perform other functions.

Queuing the video content for the particular console and the particular camera as of the appropriate time and date is done simply by clicking on a copy of the tracking system message that is re-created in the process tab of the display system.

Other implementations are also within the scope of the following claims.

1. A computer-implemented method comprising
enabling a user of a factory automation application that is presenting a graphical user interface at a user console to select at least one of (a) a factory automation event or (b) a past time segment in the factory automation, and
in response to the user selection, presenting both (a) stored audio-video factory automation content, and (b) stored audio-video console content, for the selected event or time segment.

2. The method of claim 1 in which the presentations of the stored factory automation content and the stored console content are coordinated in time.

3. The method of claim 1 in which the user can select the factory automation event from a list of events.

4. The method of claim 1 in which the user can select the past time on a graphically presented time scale.

5. The method of claim 1 in which the audio-video factory automation content comprises a video capture of a factory automation step.

6. The method of claim 1 in which the console content comprises a video capture of the console screen.

7. The method of claim 1 in which the stored factory automation content and the stored audio-video console content are presented simultaneously.

8. A computer-implemented method comprising
enabling a user of a graphical user interface of an audio-video presentation application, to select a combination of (a) an item of stored audio-video console content associated with an event or time segment of factory automation, and (a) one or more items of stored audio-video factory automation content also associated with the event or time segment, and
displaying the combination of content items simultaneously to the user, the presentation of the content items being coordinated in time.

9. The method of claim 8 in which the audio-video presentation application is used by a different person than the person who used a factory automation application that was the subject of the stored audio-video console content.

10. A computer-implemented method comprising
locating, in a message stored in a database of a factory automation system, a string of characters that were pre-specified by a user of the system as being associated with an identified audio-video source of the factory automation system, and
in connection with a user selecting the message in a user interface, automatically presenting previously stored audio-video content associated with the identified audio-video source.

11. The method of claim 10 in which the database comprises an SQL database.

12. The method of claim 10 also comprising, displaying an icon with the message in the user interface, and enabling the user to invoke the icon to cause the previously stored audio-video content to be presented.

13. The method of claim 10 in which the audio-video source comprises a video camera or a video capture application.
